(19) United States
(12) Patent Application Publication
(10) Pub. No.: US 2017/0217199 A1
(43) Pub. Date: Aug. 3, 2017

(54) FLOW PATH STRUCTURE, LIQUID EJECTING UNIT, AND LIQUID EJECTING APPARATUS

(71) Applicant: SEIKO EPSON CORPORATION, Tokyo (JP)

(72) Inventors: Ken YAMAGISHI, Shiojiri-shi (JP); Hisashi SATO, Shiojiri-shi (JP); Kentaro MURAKAMI, Matsumoto-shi (JP); Nagatoshi KASAHARA, Matsumoto-shi (JP); Kazuya TAJIMA, Matsumoto-shi (JP)

(21) Appl. No.: 15/418,934

(22) Filed: Jan. 30, 2017

(30) Foreign Application Priority Data
Feb. 2, 2016 (JP) 2016-017936
May 9, 2016 (JP) 2016-094100
Oct. 20, 2016 (JP) 2016-205946

(51) Int. Cl. B41J 2/175

(52) U.S. Cl. CPC B41J 2/17596

(57) ABSTRACT

There is provided a flow path structure including: a storage chamber that stores a liquid; a pressure receiver that receives a first pressure inside the storage chamber and a second pressure outside the storage chamber; a valve that changes the first pressure according to the movement of the pressure receiver; and a pressing portion that presses the pressure receiver according to the supply pressure of the fluid from a fluid supply source, in which an area of the front end of the pressing portion that presses the pressure receiver is smaller than an area of a rear end that receives the supply pressure.

### CROSS-REFERENCE TO RELATED APPLICATIONS

The present application claims priority to Japanese Patent Application No. 2016-205946, filed Oct. 20, 2016, Japanese Patent Application No. 2016-094100, filed May 9, 2016, and Japanese Patent Application No. 2016-017936, filed Feb. 2, 2016, which applications are hereby incorporated by reference in their entirety.

### BACKGROUND

1. Technical Field

The present invention relates to a flow path structure including a liquid storage chamber which stores a liquid and a valve which is opened according to pressure, a liquid ejecting unit including the flow path structure, and a liquid ejecting apparatus including the flow path structure.

2. Related Art

A liquid ejecting unit as a flow path structure ejects liquid such as ink or the like that is supplied from a liquid storage unit such as an ink tank or the like from a plurality of nozzles by the pressure change of a pressure generating unit, as a droplet. In the related art, a configuration in which a pressure adjustment valve that is opened by the pressure of the flow path at the downstream side in the middle being a negative pressure is provided such that the liquid such as ink or the like supplied from the liquid storage unit is supplied to the liquid ejecting unit at a predetermined pressure, has been proposed (for example, refer to JP-A-2012-111044).

In JP-A-2012-111044, a configuration in which a pressing mechanism that opens a valve by pressing the valve from the outside regardless of the pressure of the flow path at the downstream side is provided is disclosed.

In addition, a configuration in which fluid such as air or the like is pressurized and supplied and thus a valve is opened by pressing a pressure adjustment valve using the pressurized fluid is disclosed (for example, refer to JP-A-2015-189201).

However, in a case where the valve is pressed from the outside, when the entire surface of the pressure receiving portion is pressed, since the reaction force received from the pressure receiving portion is increased, it is necessary to increase the pressure for pressing the pressure receiving portion. For this reason, as a pressure feed unit such as a pump for pressurizing the liquid to press the pressure receiving portion, a device with a high pressurizing capability or a large size is required, and this results in an increase in size and cost.

In addition, in a case where the valve is pressed and opened and the pressure in the ink that presses the pressure receiving portion increases, there is a case where the posture of the expansion/contraction mechanism cannot be maintained.

Such a problem is not limited to a flow path structure including an ink jet recording head, and also present in a flow path structure used for other devices.

### SUMMARY

An advantage of some aspects of the invention is to provide a flow path structure, a liquid ejecting unit, and a liquid ejecting apparatus that can press a pressure receiving plate with a small force and maintain a posture of a pressing portion.

According to an aspect of the invention, there is provided a flow path structure including: a storage chamber that stores a liquid; a pressure receiving portion that receives a first pressure in the storage chamber and a second pressure outside the storage chamber; a valve that changes the first pressure according to the movement of the pressure receiving portion; and a pressing portion that presses the pressure receiving portion according to the supply pressure of the fluid from a fluid supply source, in which an area of the front end of the pressing portion that presses the pressure receiving portion is smaller than an area of a rear end that receives the supply pressure.

In this aspect, the pressing portion for pressing the pressure receiving portion is provided, and the area of the front end of the pressing portion that presses the pressure receiving portion is smaller than the area of the rear end that receives the supply pressure. Thus, it is possible to easily receive the supply pressure by the rear end with a wide area, and reduce the reaction force from the pressure receiving portion by the front end with a small area. Therefore, there is no need for high pressure as the supply pressure, and it is possible to supply the fluid from the fluid supply source in a short time and reduce the load on the fluid supply source. In addition, the reaction force from the pressure receiving portion can be reduced, and thus it is possible to easily maintain the posture of the pressing portion and stably maintain the state where an opening/closing valve is opened.

In the aspect, preferably, the flow path structure further includes a pressure receiving plate provided on the pressure receiving portion. According to this aspect, the pressure receiving plate is provided, and thus, when the pressing portion presses the pressure receiving portion, it is possible to prevent deformation and breakage of the pressure receiving portion.

In the aspect, preferably, the pressure receiving plate is larger than the front end. According to this aspect, even in a case where the pressure receiving plate and the front end of the pressing portion are misaligned, it is possible to reliably press the pressure receiving plate by the front end of the pressing portion.

In the aspect, preferably, the pressure receiving plate includes a return that is separated from the pressure receiving portion. According to this aspect, the return is provided on the pressure receiving plate, and thus the strength of the pressure receiving plate is increased, thereby preventing deformation of the pressure receiving plate. Further, the return is provided in a direction away from the pressure receiving portion, and thus it is possible to prevent the pressure receiving portion from being damaged by the edge of the pressure receiving plate.

In the aspect, preferably, the return is in the storage chamber, and the pressure receiving portion is pressed by the pressing portion to be brought into contact with the storage chamber. According to this aspect, excessive deformation of the pressure receiving portion can be prevented, and thus it is possible to prevent breakage of the pressure receiving portion and the pressing portion due to excessive deformation.

In the aspect, preferably, the pressure receiving portion includes a portion whose one end portion is supported by the flow path structure, a to-be-pressed portion to be pressed by the pressing portion, and a contact portion which is brought into contact with the valve between the portion and the to-be-pressed portion. According to this aspect, variations in the contact portion being brought in contact with the valve body with respect to the variations in the to-be-pressed portion can be reduced, and thus it is possible to improve accuracy in the position of the valve body, thereby improving the opening/closing accuracy of the valve body.

In the aspect, preferably, in the pressing portion, the thickness of the portion other than the front end is thinner than the thickness of the front end. According to this aspect, the thickness of the portion other than the front end is thin, and thus the portion other than the front end can be easily deformed. Therefore, it is possible to easily move the front end and easily maintain the posture of the front end.

In the aspect, preferably, the pressing portion includes bent portions that are bent. According to this aspect, the area of the rear end surface that receives the supply pressure is increased, and thus it is possible to operate the flow path structure with a low supply pressure. Further, the bent portions can be deformed so as to widen the bend angles of the bent portions, and thus it is possible to obtain a large displacement amount with a relatively low pressure.

In the aspect, preferably, a wall is provided on a side opposite to the pressure receiving portion with the pressing portion interposed therebetween, and the wall has a plurality of protrusion portions that are brought into contact with the pressing portion and recess portions provided between the plurality of protrusion portions. According to this aspect, the pressing portion is brought into contact with the protrusion portions, and thus the contact area between the pressing portion and the wall can be reduced. Therefore, it is possible to prevent the pressing portion from sticking to the wall due to dew condensation or the like.

In the aspect, preferably, a plurality of recess portions are provided, and the fluid is supplied from each of the recess portions. According to this aspect, even though one of the recess portions is clogged, the fluid can be supplied from other recess portions, and thus it is possible to reliably operate the pressing portion.

In the aspect, preferably, the pressure receiving portion includes a plurality of protrusion portions and recess portions provided between the plurality of protrusion portions at a position to be pressed by the pressing portion. According to this aspect, the pressing portion is brought into contact with the plurality of protrusion portions of the pressure receiving portion, and thus the contact area between the pressing portion and the pressure receiving portion can be reduced. Therefore, it is possible to prevent the pressing portion from sticking to the pressure receiving portion due to dew condensation or the like.

In the aspect, preferably, the pressing portion presses the pressure receiving portion to be in a first state where the pressure receiving portion is pressed to the extent that the valve is opened, and a second state where the pressure receiving portion is pressed to the extent that the valve is not opened. According to this aspect, it is possible to operate the pressing portion in multiple stages and press the pressure receiving portion in multiple stages.

In the aspect, preferably, the pressing portion includes first portions to be deformed with a high supply pressure and second portions to be deformed with a low supply pressure, the first state is made by the deformation of the first portions, and the second state is made by the deformation of the second portions. According to this aspect, it is possible to easily realize the first state where the valve is opened by the deformation of the first portions and the second state where the valve is not opened by the deformation of the second portions.

Further, according to another aspect of the invention, there is provided a liquid ejecting unit including: a flow path structure according to the aspect; and a liquid ejecting portion that changes the first pressure by ejecting the liquid in the storage chamber.

According to this aspect, even though the liquid in the storage chamber is consumed by ejection of the liquid in the storage chamber by the liquid ejecting portion, the pressure receiving portion operates based on the pressure in the storage chamber, and thus it is possible to supply the liquid into the storage chamber by opening the valve. Accordingly, it is possible to supply the liquid to the liquid ejecting portion with a constant pressure.

According to still another aspect of the invention, there is provided a liquid ejecting apparatus including: a flow path structure according to the aspect; a liquid ejecting portion that changes the first pressure by ejecting the liquid in the storage chamber from nozzles; and a control unit that controls the flow path structure so as to swing the meniscus of the liquid in the nozzles of the liquid ejecting portion by pressing the pressure receiving portion in the second state.

According to this aspect, the meniscus of the liquid in the nozzle of the liquid ejecting portion is swung by the flow path structure, and thus it is possible to prevent the liquid near the nozzle from drying. In addition, the meniscus of the liquid in the nozzle can be greatly swung by using the flow path structure, compared to the case of using the piezoelectric element or the like.

### BRIEF DESCRIPTION OF THE DRAWINGS

The invention will be described with reference to the accompanying drawings, wherein like numbers reference like elements.

FIG. 1 is a configuration diagram of a liquid ejecting apparatus according to a first embodiment of the invention.

FIG. 2 is an exploded perspective view of a liquid ejecting head.

FIG. 3 is a sectional view of a liquid ejecting portion.

FIG. 4 is an explanatory diagram of the internal flow path of a liquid ejecting unit.

FIG. 5 is a configuration diagram of an opening/closing valve of a valve mechanism unit.

FIG. 6 is an explanatory diagram illustrating a degassing space and a check valve.

FIG. 7 is an explanatory diagram illustrating a state of the liquid ejecting head at the time of initial filling.

FIG. 8 is an explanatory diagram illustrating a state of the liquid ejecting head at the time of normal use.

FIG. 9 is an explanatory diagram illustrating a state of the liquid ejecting head at the time of a degassing operation.

FIG. 10 is a configuration diagram of an opening/closing valve of a valve mechanism unit according to a second embodiment of the invention.

FIG. 11 is a configuration diagram of the valve mechanism of the valve mechanism unit according to the second embodiment of the invention.

FIG. 12 is a diagram for explaining an operation of the opening/closing valve of the valve mechanism unit.

FIG. 13 is a configuration diagram of an opening/closing valve of a valve mechanism unit according to a third embodiment of the invention.

FIG. 14 is a diagram for explaining an operation of the opening/closing valve of the valve mechanism unit.

FIG. 15 is a diagram for explaining an operation of the opening/closing valve of the valve mechanism unit.

FIG. 16 is a block diagram illustrating a function realization section of a control unit.

FIG. 17 is a plan view of a movable film according to a fourth embodiment of the invention.

FIG. 18 is a configuration diagram of the valve mechanism of a valve mechanism unit according to the fourth embodiment of the invention.

FIG. 19 is a diagram for explaining an operation of the opening/closing valve of the valve mechanism unit.

### DESCRIPTION OF EXEMPLARY EMBODIMENTS

Hereinafter, the invention will be described in detail based on embodiments.

### First Embodiment

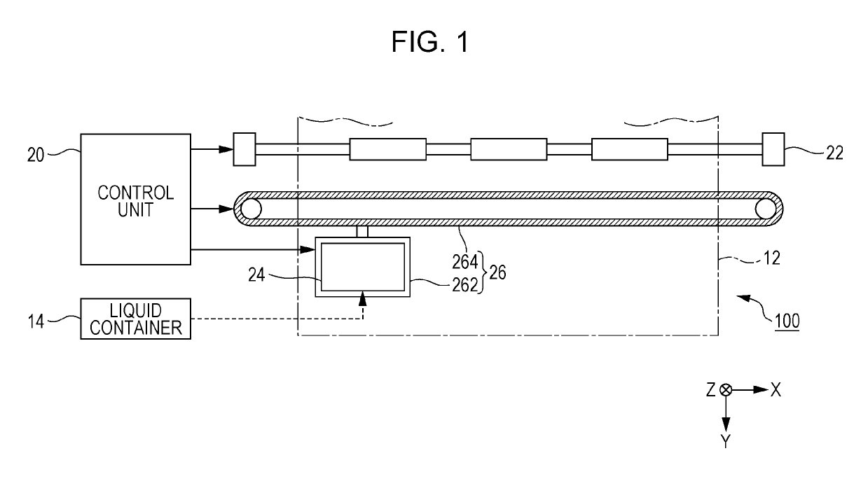

FIG. 1 is a configuration diagram of a liquid ejecting apparatus 100 according to a first embodiment of the invention. The liquid ejecting apparatus 100 according to the present embodiment is an ink jet type printing apparatus that ejects ink as an example of liquid onto a medium 12. The medium 12 is typically printing paper, but any printing object such as a resin film and a fabric may be used as the medium 12. A liquid container 14 that stores ink is fixed to the liquid ejecting apparatus 100. For example, a cartridge that can be attached and detached to and from the liquid ejecting apparatus 100, a bag-shaped ink pack that is formed by a flexible film, or an ink tank that can supplement ink is used as the liquid container 14. A plurality of types of ink with different colors are stored in the liquid container 14.

As illustrated in FIG. 1, the liquid ejecting apparatus 100 includes a control unit 20 as a controller, a transport mechanism 22, and a liquid ejecting head 24. The control unit 20 is configured to include, for example, a control device such as a central processing unit (CPU), a field programmable gate array (FPGA), or the like and a memory device such as a semiconductor memory (not illustrated), and overall controls each element of the liquid ejecting apparatus 100 by executing a program stored in the memory device by the control device. The transport mechanism 22 transports the medium 12 to a Y-direction under the control of the control unit 20.

The liquid ejecting apparatus 100 according to the first embodiment includes a movement mechanism 26. The movement mechanism 26 is a mechanism that reciprocates the liquid ejecting head 24 to an X-direction under the control by the control unit 20. The X-direction in which the liquid ejecting head 24 is reciprocated is a direction that intersects (typically is orthogonal to) the Y-direction in which the medium 12 is transported. The movement mechanism 26 according to the first embodiment includes a transport body 262 and a transport belt 264. The transport body 262 is a substantially box-shaped structure (carriage) that supports the liquid ejecting head 24, and fixed to the transport belt 264. The transport belt 264 is an endless belt that is placed along the X-direction. The transport belt 264 is rotated under the control of the control unit 20, and thus the liquid ejecting head 24 is reciprocated along the X-direction together with the transport body 262. The liquid container 14 may be mounted to the transport body 262 together with the liquid ejecting head 24.

The liquid ejecting head 24 ejects the ink supplied from the liquid container 14 onto the medium 12 under the control of the control unit 20. The liquid ejecting head 24 ejects the ink onto the medium 12 during a period for which the transport of the medium 12 by the transport mechanism 22 and the transport of the liquid ejecting head 24 by the movement mechanism 26 are executed, and thus a desired image is formed on the medium 12. In the following description, a direction perpendicular to an X-Y plane is referred to as a Z-direction. The ink ejected from the liquid ejecting head 24 proceeds to the positive side of the Z-direction and is landed on the surface of the medium 12.

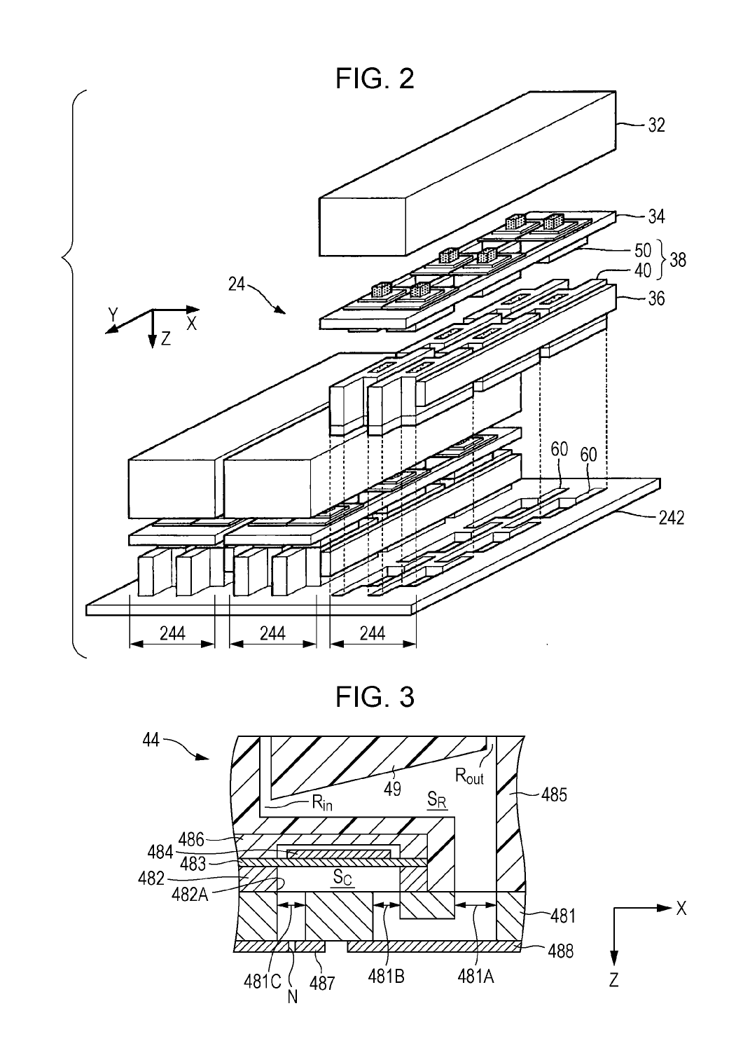

FIG. 2 is an exploded perspective view of the liquid ejecting head 24. As illustrated in FIG. 2, the liquid ejecting head 24 according to the present embodiment includes a first support body 242 and a plurality of assemblies 244. The first support body 242 is a plate-shaped member that supports the plurality of assemblies 244 (liquid ejecting head support body). The plurality of assemblies 244 are fixed to the first support body 242 in a state of being arranged in the X-direction. As typically illustrated for one of the assemblies 244, each of the plurality of assemblies 244 includes a connection unit 32, a second support body 34, a distribution flow path 36, a plurality of (in this embodiment, six) liquid ejecting modules 38. The total number of the assemblies 244 that constitute the liquid ejecting head 24 and the total number of the liquid ejecting modules 38 that constitute the assembly 244 are not limited to the example illustrated in FIG. 2.

The plurality of liquid ejecting modules 38 are disposed in two rows at the second support body 34 that is positioned directly below the connection unit 32, and the distribution flow path 36 is disposed at the side of the plurality of liquid ejecting modules 38. The distribution flow path 36 is a structure in which a flow path for distributing the ink supplied from the liquid container 14 to each of the plurality of liquid ejecting modules 38 is formed, and is configured to elongate in the Y-direction so as to across the plurality of liquid ejecting modules 38.

The liquid ejecting module 38 includes a liquid ejecting unit 40 and a coupling unit 50. The liquid ejecting unit 40 ejects the ink supplied from the liquid container 14 via the distribution flow path 36, onto the medium 12. The liquid ejecting unit 40 according to the present embodiment includes a valve mechanism unit 41 as a flow path structure according to the present embodiment, a flow path unit 42, and a liquid ejecting portion 44. The valve mechanism unit 41 includes a valve mechanism that controls the opening/closing of the flow path of the ink supplied from the distribution flow path 36. For convenience, the valve mechanism unit 41 is not illustrated in FIG. 2. The flow path in the distribution flow path 36 and the flow path in the valve mechanism unit 41 communicate with each other.

The liquid ejecting portion 44 of the liquid ejecting unit 40 ejects the ink from a plurality of nozzles. The flow path unit 42 is a structure in which the flow path for supplying the ink passed through the valve mechanism unit 41 to the liquid ejecting portion 44 is formed therein.

Hereinafter, an example of the liquid ejecting portion 44 according to the present embodiment will be described with reference to FIG. 3. FIG. 3 is a sectional view of the portion corresponding to any one nozzle N of the liquid ejecting head.

As illustrated in FIG. 3, the liquid ejecting portion 44 according to the present embodiment is a structure in which a pressure chamber substrate 482, a vibration plate 483, a piezoelectric element 484, a housing portion 485, and a sealing body 486 are disposed on one side of a flow path substrate 481, and in which a nozzle plate 487 and a buffer plate 488 are disposed on the other side of the flow path substrate 481. The flow path substrate 481, the pressure chamber substrate 482, and the nozzle plate 487 are formed with, for example, a flat plate member of silicon, and the housing portion 485 is formed, for example, by injection molding of a resin material. The plurality of nozzles N are formed in the nozzle plate 487. The surface of the nozzle plate 487 that is opposite to the flow path substrate 481 corresponds to the ejecting face J.

In the flow path substrate 481, an opening portion 481A, a branch flow path (throttle flow path) 481B, and a communication flow path 481C are formed. The branch flow path 481B and the communication flow path 481C are a through-hole that is formed for each of the nozzles N, and the opening portion 481A is an opening that is continuous across the plurality of nozzles N. The buffer plate 488 is a flat plate member which is provided on the surface of the flow path substrate 481 that is opposite to the pressure chamber substrate 482 and closes the opening portion 481A (a compliance substrate). The pressure variation in the opening portion 481A is absorbed by the buffer plate 488.

In the housing portion 485, a common liquid chamber (reservoir) S_{R} that communicates with the opening portion 481A of the flow path substrate 481 is formed. The common liquid chamber S_{R} is a space for storing the ink to be supplied to the plurality of nozzles N that constitute one of the first column G₁ and the second column G₂, and is continuous across the plurality of nozzles N. An inflow port Rᵢₙ into which the ink supplied from the upstream side flows is formed in the common liquid chamber S_{R}.

An opening portion 482A is formed in the pressure chamber substrate 482 for each of the nozzles N. The vibration plate 483 is a flat plate member which is elastically deformable and provided on the surface of the pressure chamber substrate 482 that is opposite to the flow path substrate 481. The space that is interposed between the vibration plate 483 and the flow path substrate 481 at the inside of the opening portion 482A of the pressure chamber substrate 482 functions as a pressure chamber S_{C} (cavity) in which the ink supplied through the branch flow path 481B from the common liquid chamber S_{R} is filled. Each pressure chamber S_{C} communicates with the nozzles N through the communication flow path 481C of the flow path substrate 481.

The piezoelectric element 484 is formed on the surface of the vibration plate 483 that is opposite to the pressure chamber substrate 482 for each of the nozzles N. Each piezoelectric element 484 is a driving element in which a piezoelectric body is interposed between electrodes that are opposite to each other. When the piezoelectric element 484 is deformed by the supply of the driving signal and thus the vibration plate 483 is vibrated, the pressure in the pressure chamber S_{C} varies, and thus the ink in the pressure chamber S_{C} is ejected from the nozzles N. The sealing body 486 protects each piezoelectric element 484.

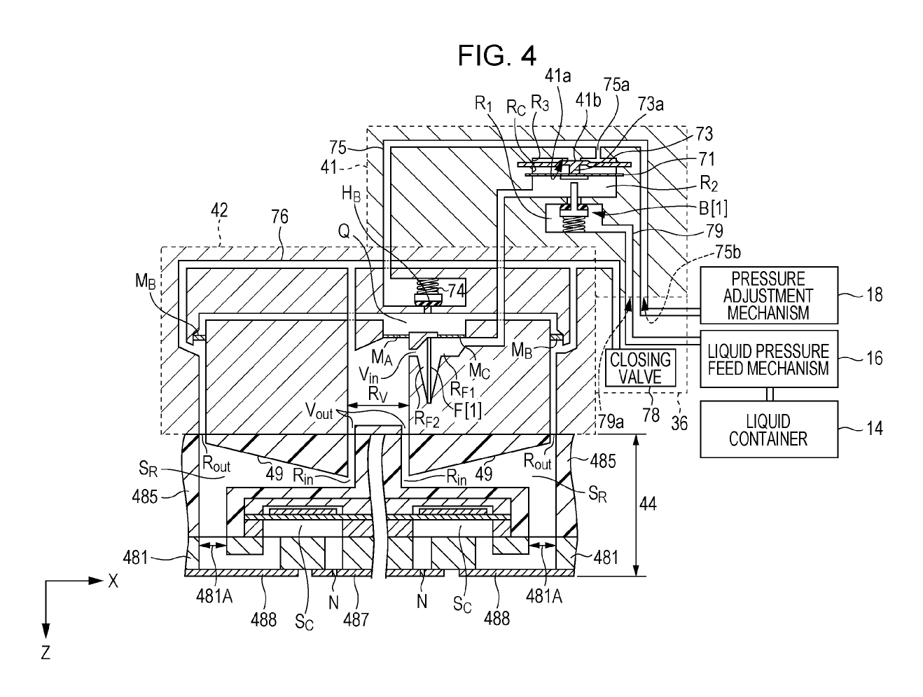

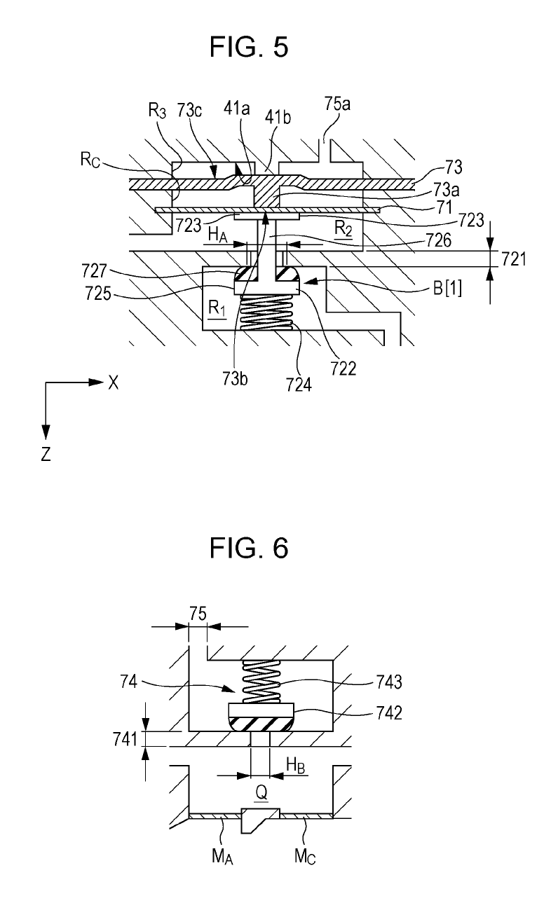

Hereinafter, the valve mechanism unit 41 of the liquid ejecting unit 40 will be described with reference to FIGS. 4 and 5. FIG. 5 is a sectional view of the valve mechanism unit illustrated in FIG. 4.

As illustrated in FIGS. 4 and 5, a space R₁, a space R₂, a control chamber R_{C}, and a space R₃ are formed in the inside of the valve mechanism unit 41.

The space R₁ is connected to a liquid pressure feed mechanism 16. The liquid pressure feed mechanism 16 is a mechanism that supplies, that is, pressure-feeds the ink stored in the liquid container 14 to the liquid ejecting unit 40 in a pressurized state. The opening/closing valve B[1] is provided between the space R₁ and the space R₂, and a movable film 71 as a pressure receiving portion is interposed between the space R₂ and the control chamber R_{C}. In this embodiment, the space R₂ is a storage chamber in which the ink is stored, and the control chamber R_{C} is outside the storage chamber. The movable film 71 constitutes a part of the wall surface of the space R₂ as the storage chamber. A pressing portion 73 is interposed between the control chamber R_{C} and the space R₃. The space R3 is connected to a degassing path 75 connected to a pressure adjustment mechanism 18 as a fluid supply source. In the present embodiment, the degassing path 75 is connected to an opening portion 75a which is opened to the wall 41a of the space R₃ that faces the pressing portion 73 in the Z-direction.

As illustrated in FIG. 5, the opening/closing valve B[1] includes a valve seat 721, a valve body 722, a pressure receiving plate 723, and a spring 724. The valve seat 721 is a flat plate-shaped portion that partitions the space R₁ and the space R₂. In the valve seat 721, a communication hole H_{A} that allows the space R₁ to communicate with the space R₂ is formed. The pressure receiving plate 723 is a substantially circular-shaped flat plate member which is provided on the surface of the movable film 71 that faces the valve seat 721. That is, the pressure receiving plate 723 is provided on the movable film 71. In this way, the pressure receiving plate 723 is provided on the movable film 71, and thus it is possible to prevent damage and deformation of the movable film 71, compared to the case where the valve body 722 is brought into direct contact with the movable film 71. The pressure receiving plate 723 may be bonded to the movable film 71, or may not be bonded to the movable film 71. In other words, the state where the pressure receiving plate 723 is provided on the movable film 71 includes a state where the pressure receiving plate 723 is bonded to the movable film 71, and a state where the pressure receiving plate 723 is disposed so as to be brought into contact with the movable film 71 without being bonded to the movable film 71. In a case where the pressure receiving plate 723 is bonded to the movable film 71, the pressure that the front end of the pressing portion 73 to be described in detail receives from the ink via the movable film 71 depends on the area of the pressure receiving plate 723. In a case where the pressure receiving plate 723 is not bonded to the movable film 71, the pressure that the front end of the pressing portion 73 receives from the ink via the movable film 71 depends on the area of the front end of the pressing portion 73. In the present embodiment, the pressure receiving plate 723 is not bonded to the movable film 71.

The valve body 722 includes a base portion 725, a valve shaft 726, and a sealing portion (seal) 727. The valve shaft 726 projects vertically from the surface of the base portion 725, and the ring-shaped sealing portion 727 that surrounds the valve shaft 726 in a plan view is provided on the surface of the base portion 725. The valve body 722 is disposed within the space R₁ in the state where the valve shaft 726 is inserted into the communication hole H_{A}, and energized to the valve seat 721 side by the spring 724. A gap is formed between the outer peripheral face of the valve shaft 726 and the inner peripheral face of the communication hole H_{A}.

As illustrated in FIG. 5, the pressing portion 73 is interposed between the control chamber R_{C} and the space R₃. That is, the pressing portion 73 is provided so as to partition the control chamber R_{C} and the space R₃. The pressing portion 73 is configured with a plate-shaped member formed of an elastic material such as rubber. In the present embodiment, when the space R₃ is pressurized by the pressurization operation of the pressure adjustment mechanism 18 via the degassing path 75, the pressing portion 73 elastically deforms so as to protrude in a convex shape toward the inside of the control chamber R_{C}, that is, toward the movable film 71. The pressing portion 73 has a flat plate shape in a case where the pressurization operation is not performed.

The area of the front end of the pressing portion 73 that presses the movable film 71 is smaller than the area of the rear end of the pressing portion 73 that receives the supply pressure. In the present embodiment, a projection portion 73a that projects toward the movable film 71 is provided on the surface of the pressing portion 73 that faces the movable film 71, and the area of the front end surface 73b of the projection portion 73a is smaller than the area of the rear end surface 73c that constitutes a part of the wall of the space R₃ which receives the supply pressure from the pressure adjustment mechanism 18. The space R₃ is pressurized by the pressure adjustment mechanism 18 via the degassing path 75, and thus, when the pressing portion 73 is deformed toward the movable film 71 in a convex shape, the front end surface 73b of the projection portion 73a is brought into contact with the movable film 71 and presses the movable film 71. That is, the pressing portion 73 is deformed during the pressurization operation, and thus the region other than the front end surface 73b in the pressing portion 73 is not brought into contact with the movable film 71.

In the pressing portion 73, the thickness in the Z-direction of a portion other than the portion at which the projection portion 73a is provided is thinner than the thickness in the Z-direction of the portion at which the projection portion 73a is provided. That is, the projection portion 73a is formed by increasing the thickness of the plate-shaped member in the Z-direction. In this way, the thickness of the portion other than the portion at which the projection portion 73a is provided is thinner than that of the region at which the projection portion 73a is provided, and thus the portion other than the projection portion 73a in the pressing portion 73 can be easily deformed. In this regard, in a case where the thickness of the portion other than the projection portion 73a in the pressing portion 73 is the same as that of the projection portion 73a, the portion other than the projection portion 73a in the pressing portion 73 is unlikely to be deformed, and the portion at which the projection portion 73a is provided may be deformed. As a result, there is a concern that it is difficult to press the movable film 71 with high accuracy. In the present embodiment, the thickness of the portion other than the projection portion 73a is thinner than that of the projection portion 73a, and thus the portion other than the projection portion 73a can be easily deformed. In addition, the shape of the projection portion 73a can be stabilized, and thus it is possible to press the movable film 71 with high accuracy.

The area of the front end surface 73b of the projection portion 73a is smaller than the area of the region of the pressing portion 73 that faces the movable portion of the movable film 71. That is, the entire region of the pressing portion 73 that faces the flexible portion of the movable film 71 does not become the projection portion 73a, and only the projection portion 73a is projected. Therefore, the contact area between the projection portion 73a and the movable film 71 is smaller than the area of the movable portion of the movable film 71.

As described above, the pressure receiving plate 723 is provided on the movable film 71 pressed by the pressing portion 73, and thus, when the pressing portion 73 presses the movable film 71, it is possible to prevent deformation and breakage of the movable film 71 such as extension or tear of the movable film 71.

The pressure receiving plate 723 provided on the movable film 71 has an area larger than the area of the front end surface 73b of the projection portion 73a of the pressing portion 73. The fact that the pressure receiving plate 723 has an area larger than the area of the front end surface 73b means that the pressure receiving plate 723 has a wider width than the front end surface 73b in both the X-direction and the Y-direction. In this way, the pressure receiving plate 723 has an area larger than the area of the front end surface 73b of the projection portion 73a, and thus, even in a case where the pressure receiving plate 723 and the front end surface 73b of the pressing portion 73 are misaligned, it is possible to reliably press the pressure receiving plate 723 by the front end surface 73b of the pressing portion 73.

As illustrated in FIG. 4, the degassing path 75 is connected to the pressure adjustment mechanism 18 as a fluid supply source via the flow path in the distribution flow path 36. The pressure adjustment mechanism 18 can selectively execute a pressurization operation for supplying air as fluid to the flow path that is connected to the pressure adjustment mechanism 18, and a depressurization operation for sucking air as fluid from the flow path, according to an instruction from the control unit 20. The pressing portion 73 is deformed so as to protrude toward the movable film 71 by supplying air from the pressure adjustment mechanism 18 to the internal space (that is, pressurizing), and the deformation of the pressing portion 73 is released by sucking air using the pressure adjustment mechanism 18 (that is, depressurizing).

In the state where the deformation of the pressing portion 73 is released, as illustrated in FIG. 5, in a case where the pressure in the space R₂ is maintained within a predetermined range, the valve body 722 is energized by the spring 724, and thus the sealing portion 727 is brought to close contact with the surface of the valve seat 721. Therefore, the space R₁ and the space R₂ are separated from each other. On the other hand, when the pressure in the space R₂ is lowered to a value less than a predetermined threshold value due to the ejection of the ink by the liquid ejecting portion 44 or the suction of the ink from the outside, the movable film 71 is displaced to the valve seat 721 side, and thus the pressure receiving plate 723 pressurize the valve shaft 726. As a result, the valve body 722 is moved against the energization by the spring 724, and thus the sealing portion 727 is separated from the valve seat 721. Therefore, the space R₁ and the space R₂ communicate with each other via the communication hole H_{A}. That is, the movable film 71 moves according to the pressure difference between a first pressure in the space R₂ as the storage chamber and a second pressure in the control chamber R_{C} outside the storage chamber. The control chamber R_{C} may be opened to the atmosphere. Accordingly, the movable film 71 can be moved according to the pressure difference between the atmospheric pressure and the pressure in the space R₂.

When the pressing portion 73 is deformed due to the pressurization by the pressure adjustment mechanism 18, the movable film 71 is displaced to the valve seat 721 side due to the pressurization by the pressing portion 73. Therefore, the valve body 722 is moved due to the pressurization by the pressure receiving plate 723, and thus the opening/closing valve B[1] is opened. In other words, regardless of the level of the pressure in the space R₂, it is possible to forcibly open the opening/closing valve B[1] by the pressurization by the pressure adjustment mechanism 18. That is, the movable film 71 moves according to the pressure difference between the first pressure in the space R₂ as the storage chamber and the second pressure in the control chamber R_{C} outside the storage chamber, and moves according to the press by the pressing portion 73.

In the present embodiment, the pressing portion 73 is deformed due to the pressurization by the pressure adjustment mechanism 18, and the movable film 71 is deformed by the pressing portion 73. Thus, the pressing portion 73 can easily receive the pressure from the pressure adjustment mechanism 18, and reduce repulsion due to the pressure of the ink in the space R₂ that presses the movable film 71.

In a case where the movable film 71 is directly pressed by pressurizing the air in the control chamber R_{C} without providing the pressing portion 73, unless the pressure in the control chamber R_{C} is larger than the pressure of the ink in the space R₂, the valve body 722 cannot be pressed by the movable film 71. When the pressure of the ink in the space R₂ changes, a required change in the pressure of the pressure adjustment mechanism 18 also increases, and as a result, it becomes difficult to design the pressure adjustment mechanism 18. Here, when it is assumed that the pressure of the air by the pressure adjustment mechanism 18 is Pa (Pa), that the pressure of the ink is Pi (Pa), that the spring force is Fs (N), that the reaction force of the movable film 71 is F (N), and that the pressure receiving area of the movable film 71 is A (m²), a required condition for opening the opening/closing valve B[1] is represented by Pa·A>PixA+Fs+F, that is, Pa>Pi+(Fs+F)/A. As represented by this expression, in order to directly deform the movable film 71 by the pressure of the pressure adjustment mechanism 18, it is necessary to set the pressure Pa of the pressure adjustment mechanism 18 to be higher than the pressure Pi of the ink.

In this regard, in the present embodiment, the pressing portion 73 is provided, and the area of the rear end surface 73c of the pressing portion 73 that receives the supply pressure and is positioned at the degassing path 75 side is increased. Thus, it is possible to easily receive the pressure from the pressure adjustment mechanism 18 by a relatively large area. Further, it is possible to reduce the repulsion due to the pressure of the ink in the space R₂ that presses the movable film 71 by reducing the area of the front end surface 73b of the pressing portion 73 that is brought into contact with the movable film 71. For example, in a case where the ratio of the area of the front end surface 73b of the projection portion 73a of the pressing portion 73 that is brought into contact with the movable film 71 to the area of the rear end surface 73c of the pressing portion 73 is 1:5, when it is assumed that the pressure of the air by the pressure adjustment mechanism 18 is Pa (Pa), that the pressure of the ink is Pi (Pa), that the spring force is Fs (N), that the reaction force of the movable film 71 is F (N), that the pressure receiving area of the rear end surface 73c of the pressing portion 73 is A (m²), that the pressure receiving area of the front end surface 73b of the pressing portion 73 that receives the pressure from the movable film 71 is Af (m²) (=⅕·A), and that the rubber reaction force of the pressing portion 73 is Fg (N), a required condition for opening the opening/closing valve B[1] is represented by Pa·A−Fg>Pi(⅕·A)+Fs+F, that is, Pa>(⅕)Pi+(Fs+F+Fg)/A. As represented by this expression, in a case where the pressing portion 73 according to the present embodiment is provided, the pressure Pa of the pressure adjustment mechanism 18 that is required for opening the opening/closing valve B[1] can be set to reduce the influence on the pressure Pi of the ink in the space R₂ partitioned by the movable film 71 to ⅕. Therefore, the repulsive force of the pressing portion 73 by the movable film 71 decreases, and thus, even when the pressure of the degassing path 75 by the pressure adjustment mechanism 18 is low, the deformation of the pressing portion 73 can be maintained. As a result, it is unnecessary that the pressure adjustment mechanism 18 supplies high pressure to the degassing path 75, and the time until the pressure of the degassing path 75 becomes a high pressure by the pressure adjustment mechanism 18 is unnecessary. Therefore, it is possible to shorten the time required for the pressurization operation and improve the durability of the pressure adjustment mechanism 18. In addition, as the pressure adjustment mechanism 18, a device capable of outputting a high pressure is unnecessary, and thus it is possible to reduce the size of the pressure adjustment mechanism 18 and cost. Further, the pressure of the pressure adjustment mechanism 18 that is required for opening the opening/closing valve B[1] has little influence on the change in the pressure of the ink in the space R₂, and thus it is possible to simplify the design of the pressure adjustment mechanism 18. Furthermore, the area of the front end surface 73b of the projection portion 73a of the pressing portion 73 that presses the movable film 71 is smaller than the area of the region of the pressing portion 73 that faces the flexible portion of the movable film 71, and thus it is possible to reduce the influence on the pressure Pi of the ink in the space R₂ due to the pressure of the pressure adjustment mechanism 18. That is, the pressure that the movable film 71 receives from the ink in the space R₂ is absorbed by the movement of the portion of the movable film 71 other than the region which is brought into contact with the pressing portion 73 to the control chamber R_{C} side. In a case where the movable film 71 and the pressure receiving plate 723 are bonded to each other, the pressure receiving area Af may be set to the area of the pressure receiving plate 723. Even in this case, for the flexural deformation of the movable film 71, the pressure receiving plate 723 is provided with an area smaller than that of the movable portion of the movable film 71. Therefore, the influence on the pressure Pi of the ink in the space R₂ which is partitioned by the movable film 71 due to the pressure of the pressure adjustment mechanism 18, that is, the reaction force of the movable film 71 can be reduced.

As illustrated in FIG. 4, the flow path unit 42 is a structure in which the flow path for supplying the ink passed through the valve mechanism unit 41 to the liquid ejecting portion 44 is formed therein.

Specifically, the flow path unit 42 according to the present embodiment includes a degassing space Q, a filter F[1], a vertical space R_{V}, and a check valve 74. The degassing space Q is a space in which an air bubble extracted from the ink temporarily stays.

The filter F[1] is provided so as to cross the internal flow path for supplying the ink to the liquid ejecting portion 44, and collects air bubbles or foreign matters mixed into the ink. Specifically, the filter F[1] is provided so as to partition the space R_{F1} and the space R_{F2}. The space R_{F1} at the upstream side communicates with the space R₂ of the valve mechanism unit 41, and the space R_{F2} at the downstream side communicates with the vertical space R_{V}.

A gas-permeable film M_{C} (an example of a second gas-permeable film) is interposed between the space R_{F1} and the degassing space Q. Specifically, the ceiling face of the space R_{F1} is configured with the gas-permeable film M_{C}. The gas-permeable film M_{C} is a gas-permeable film body that transmits gas (air) and does not transmit liquid such as ink or the like (gas-liquid separation film), and is formed with, for example, a known polymer material. The air bubble collected by the filter F[1] reaches the ceiling face of the space R_{E}1 due to the rise by buoyancy, passes through the gas-permeable film M_{C}, and is discharged to the degassing space Q. In other words, the air bubble mixed into the ink is separated.

The vertical space R_{V} is a space for temporarily storing the ink. In the vertical space R_{V} according to the first embodiment, an inflow port Vᵢₙ into which the ink passed through the filter F[1] flows from the space R_{F2}, and outflow ports Vₒᵤₜ through which the ink flows out to the nozzles N side are formed. In other words, the ink in the space R_{F2} flows into the vertical space R_{V} via the inflow port Vᵢₙ, and the ink in the vertical space R_{V} flows into the liquid ejecting portion 44 (common liquid chamber S_{R}) via the outflow ports Vₒᵤₜ. As illustrated in FIG. 4, the inflow port Vᵢₙ is positioned at the position higher than the outflow ports Vₒᵤₜ in the vertical direction (negative Z-direction).

A gas-permeable film M_{A} (an example of a first gas-permeable film) is interposed between the vertical space R_{V} and the degassing space Q. Specifically, the ceiling face of the vertical space R_{V} is configured with the gas-permeable film M_{A}. The gas-permeable film M_{A} is a gas-permeable film body that is similar to the gas-permeable film M_{C} described above. Accordingly, the air bubble that passed through the filter F[1] and entered into the vertical space R_{V} rises by the buoyancy, passes through the gas-permeable film M_{A} of the ceiling face of the vertical space R_{V}, and is discharged to the degassing space Q. As described above, the inflow port Vᵢₙ is positioned at the position at the position higher than the outflow ports Vₒᵤₜ in the vertical direction, and thus the air bubble can effectively reach the gas-permeable film M_{A} of the ceiling face using the buoyancy in the vertical space R_{V}.

In the common liquid chamber S_{R} of the liquid ejecting portion 44, as described above, the inflow port Rᵢₙ into which the ink supplied from the outflow port Vₒᵤₜ of the vertical space R_{V} flows is formed. In other words, the ink that flowed out from the outflow port Vₒᵤₜ of the vertical space R_{V} flows into the common liquid chamber S_{R} via the inflow port Rᵢₙ, and is supplied to each pressure chamber S_{C} through the opening portion 481A. In the common liquid chamber S_{R} according to the first embodiment, a discharge port Rₒᵤₜ is formed. The discharge port Rₒᵤₜ is a flow path that is formed on the ceiling face 49 of the common liquid chamber S_{R}. As illustrated in FIG. 4, the ceiling face 49 of the common liquid chamber S_{R} is an inclined face (flat face or curved face) which rises from the inflow port Rᵢₙ side to the discharge port Rₒᵤₜ side. Therefore, the air bubble that is entered from the inflow port Rᵢₙ is guided to the discharge port Rₒᵤₜ side along the ceiling face 49 by the action of the buoyancy.

A gas-permeable film M_{B} (an example of a first gas-permeable film) is interposed between the common liquid chamber S_{R} and the degassing space Q. The gas-permeable film M_{B} is a gas-permeable film body that is similar to the gas-permeable film M_{A} or the gas-permeable film M_{C}. Therefore, the air bubble that is entered from the common liquid chamber S_{R} to the discharge port Rₒᵤₜ rises by the buoyancy, passes through the gas-permeable film M_{B}, and is discharged to the degassing space Q. As described above, the air bubble in the common liquid chamber S_{R} is guided to the discharge port Rₒᵤₜ along the ceiling face 49, and thus it is possible to effectively discharge the air bubble in the common liquid chamber S_{R}, compared to a configuration in which, for example, the ceiling face 49 of the common liquid chamber S_{R} is a horizontal plane. The gas-permeable film M_{A}, the gas-permeable film M_{B}, and the gas-permeable film M_{C} may be formed with a single film body.

As described above, in the present embodiment, the gas-permeable film M_{A} is interposed between the vertical space R_{V} and the degassing space Q, the gas-permeable film M_{B} is interposed between the common liquid chamber S_{R} and the degassing space Q, and the gas-permeable film M_{C} is interposed between the space R_{F1} and the degassing space Q. In other words, the air bubbles that passed through each of the gas-permeable film M_{A}, the gas-permeable film M_{B}, and the gas-permeable film M_{C} reach the common degassing space Q. Therefore, there is an advantage in that the structure for discharging the air bubbles is simplified, compared to a configuration in which the air bubbles extracted in each unit of the liquid ejecting unit 40 are supplied to each individual space.

As illustrated in FIG. 4, the degassing space Q communicates with the degassing path 75. The degassing path 75 is a path for discharging the air stayed in the degassing space Q to the outside of the apparatus. The check valve 74 is interposed between the degassing space Q and the degassing path 75. The check valve 74 is a valve mechanism that allows the circulation of air directed to the degassing path 75 from the degassing space Q, on the one hand, and inhibits the circulation of air directed to the degassing space Q from the degassing path 75.

FIG. 6 is an explanatory diagram focusing on the vicinity of the check valve 74 of the flow path unit 42. As illustrated in FIG. 6, the check valve 74 according to the first embodiment includes a valve seat 741, a valve body 742, and a spring 743. The valve seat 741 is a flat plate-shaped portion that partitions the degassing space Q and the degassing path 75. In the valve seat 741, a communication hole H_{B} that allows the degassing space Q to communicate with the degassing path 75 is formed. The valve body 742 is opposite to the valve seat 741, and energized to the valve seat 741 side by the spring 743. In a state where the pressure in the degassing path 75 is maintained to the pressure equal to or greater than the pressure in the degassing space Q (state where the inside of the degassing path 75 is opened to the atmosphere or pressurized), the valve body 742 is brought to close contact with the valve seat 741 by the energization of the spring 743, and thus the communication hole H_{B} is closed. Therefore, the degassing space Q and the degassing path 75 are separated from each other. On the other hand, in a state where the pressure in the degassing path 75 is less than the pressure in the degassing space Q (state where the inside of the degassing path 75 is depressurized), the valve body 742 is separated from the valve seat 741 against the energization by the spring 743. Therefore, the degassing space Q and the degassing path 75 communicate with each other via the communication hole H_{B}.

The degassing path 75 according to the present embodiment is connected to the path for coupling the pressure adjustment mechanism 18 and the control chamber R_{C} of the valve mechanism unit 41. In other words, the path connected to the pressure adjustment mechanism 18 is branched into two systems, and one of the two systems is connected to the control chamber R_{C} and the other of the two systems is connected to the degassing path 75.

As illustrated in FIG. 4, a discharge path 76 that starts from the liquid ejecting unit 40 and reaches the inside of the distribution flow path 36 via the valve mechanism unit 41 is formed. The discharge path 76 is a path that communicates with the internal flow path of the liquid ejecting unit 40 (specifically, the flow path for supplying the ink to the liquid ejecting portion 44). Specifically, the discharge path 76 communicates with the discharge port Rₒᵤₜ of the common liquid chamber S_{R} of each liquid ejecting portion 44 and the vertical space R_{V}.

The end of the discharge path 76 that is opposite to the liquid ejecting unit 40 is connected to a closing valve 78. The position at which the closing valve 78 is provided is arbitrary, but the configuration in which the closing valve 78 is provided in the distribution flow path 36 is illustrated in FIG. 4. The closing valve 78 is a valve mechanism that can close the discharge path 76 in a normal state (normally close) and temporarily open the discharge path 76 to the atmosphere.

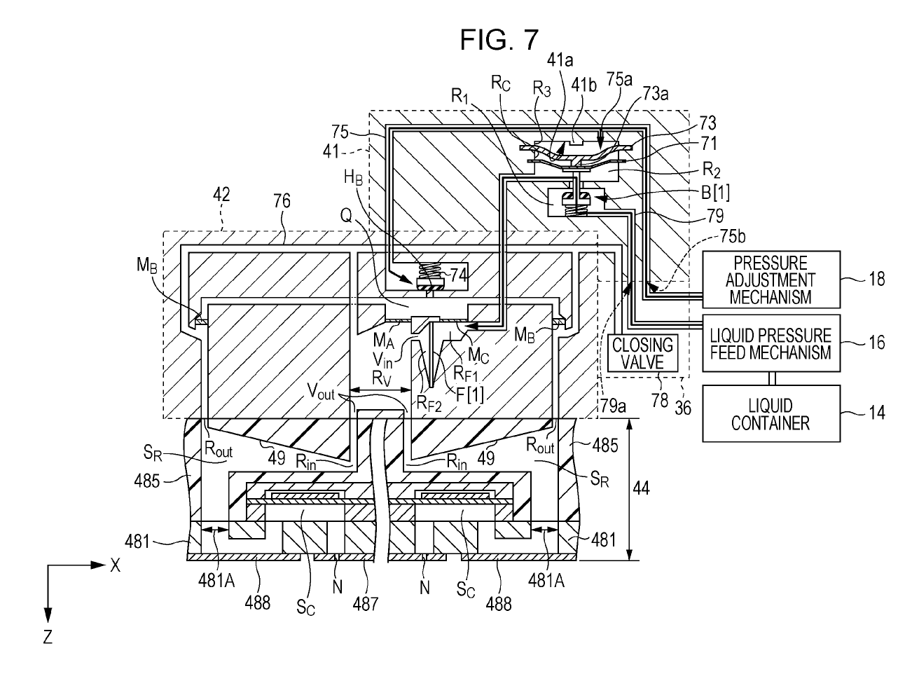

The operation of the liquid ejecting unit 40 will be described focusing on the discharge of the air bubble from the internal flow path. As illustrated in FIG. 7, in the stage of initially filling the liquid ejecting unit 40 with the ink (hereinafter, referred to as “initial filling”), the pressure adjustment mechanism 18 executes the pressurization operation. In other words, the inside of the degassing path 75 is pressurized by the supply of air. Therefore, the pressing portion 73 in the control chamber R_{C} is elastically deformed toward the movable film 71, and thus the movable film 71 and the pressure receiving plate 723 are displaced. As a result, the valve body 722 is moved due to the pressurization by the pressure receiving plate 723, and thus the space R₁ and the space R₂ communicate with each other. In a state where the degassing path 75 is pressurized, the degassing space Q and the degassing path 75 are separated from each other by the check valve 74, and thus the air in the degassing path 75 does not flow into the degassing space Q. On the other hand, in the initial filling stage, the closing valve 78 is opened.

In the present embodiment, as described above, in the pressing portion 73, as illustrated in FIG. 5, the area of the front end surface 73b that presses the movable film 71, that is, the area of the front end surface 73b of the projection portion 73a is smaller than the area of the rear end surface 73c that receives the supply pressure from the pressure adjustment mechanism 18. Therefore, the reaction force that the pressing portion 73 receives from the movable film 71, that is, the pressure that the movable film 71 receives from the ink in the space R₂ can be reduced, and thus the pressure of the degassing path 75 that is pressurized by the pressure adjustment mechanism 18 can be reduced.

In the above state, the liquid pressure feed mechanism 16 pressure-feeds the ink stored in the liquid container 14 to the internal flow path of the liquid ejecting unit 40. Specifically, the ink that is pressure-fed from the liquid pressure feed mechanism 16 is supplied to the vertical space R_{V} via the opening/closing valve B[1] in the open state, and supplied from the vertical space R_{V} to the common liquid chamber S_{R} and each pressure chamber S_{C}. As described above, since the closing valve 78 is opened, the air that is present in the internal flow path before the execution of the initial filling passes through the discharge path 76 and the closing valve 78, and is discharged to the outside of the apparatus, at the same timing of filling the internal flow path and the discharge path 76 with the ink. Therefore, the entire internal flow path including the common liquid chamber S_{R} and each pressure chamber S_{C} of the liquid ejecting unit 40 is filled with the ink, and thus the nozzles N can eject the ink by the operation of the piezoelectric element 484. As described above, in the first embodiment, the closing valve 78 is opened when the ink is pressure-fed from the liquid pressure feed mechanism 16 to the liquid ejecting unit 40, and thus it is possible to efficiently fill the internal flow path of the liquid ejecting unit 40 with the ink. When the initial filling described above is completed, the pressurization operation by the pressure adjustment mechanism 18 is stopped, and the closing valve 78 is closed.

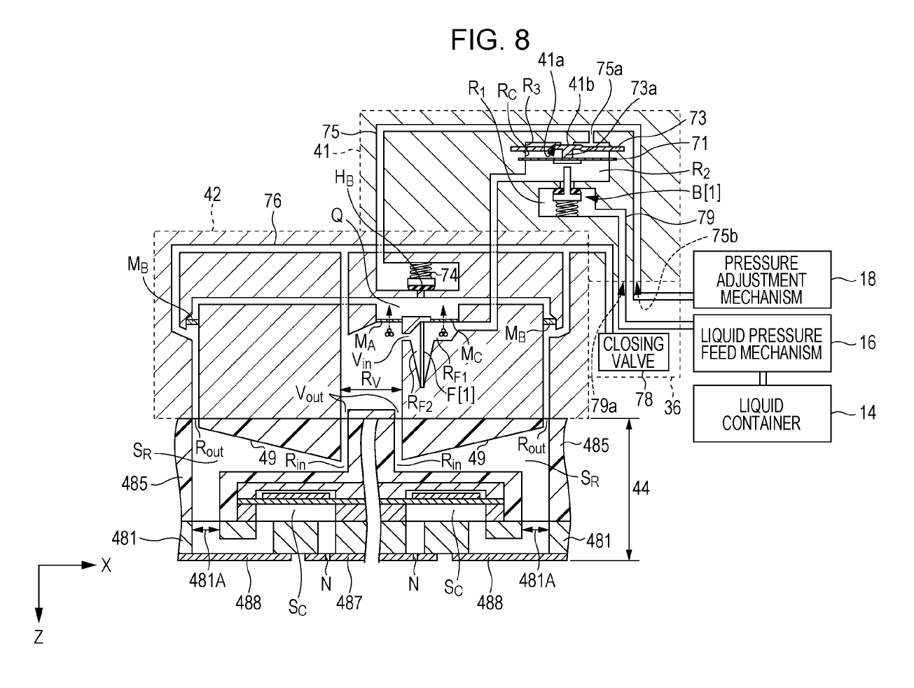

As illustrated in FIG. 8, in a state where the initial filling is completed and thus the liquid ejecting apparatus 100 can be used, the air bubble that is present in the internal flow path of the liquid ejecting unit 40 is discharged at all times to the degassing space Q. More specifically, the air bubble in the space R_{F1} is discharged to the degassing space Q via the gas-permeable film M_{C}, the air bubble in the vertical space R_{V} is discharged to the degassing space Q via the gas-permeable film M_{A}, and the air bubble in the common liquid chamber S_{R} is discharged to the degassing space Q via the gas-permeable film M_{B}. On the other hand, the opening/closing valve B[1] is closed in a state where the pressure in the space R₂ is maintained within a predetermined range, and opened in a state where the pressure in the space R₂ is less than a predetermined threshold value. When the opening/closing valve B[1] is opened, the ink supplied from the liquid pressure feed mechanism 16 flows from the space R₁ to the space R₂, and as a result, the pressure of the space R₂ increases. Thus, the opening/closing valve B[1] is closed.

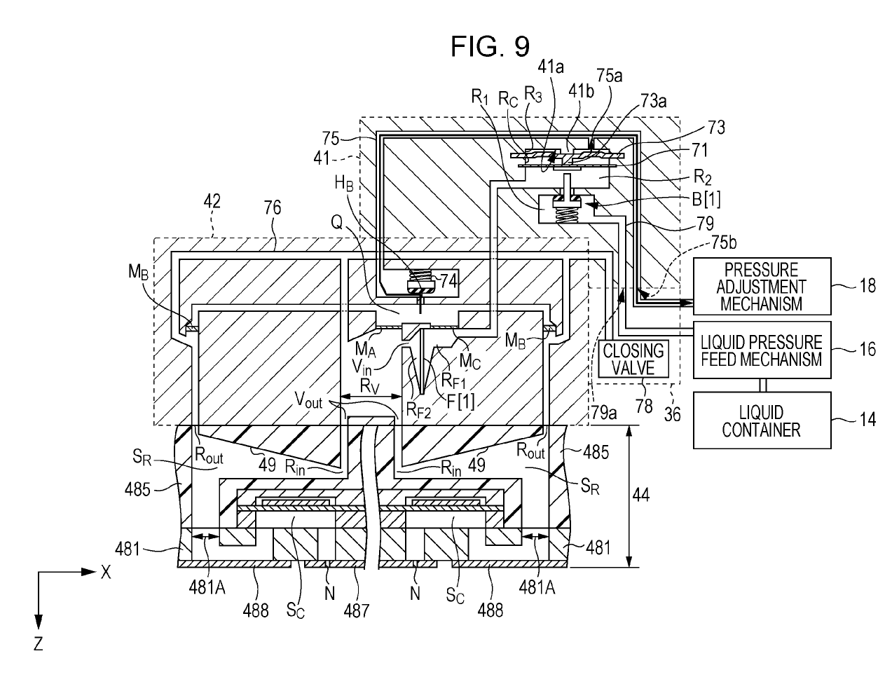

In the operating state illustrated in FIG. 8, the air stayed in the degassing space Q is discharged to the outside of the apparatus by the degassing operation. The degassing operation may be executed at any period of time, for example, such as immediately after the power-on of the liquid ejecting apparatus 100, during a period of the printing operation, or the like. FIG. 9 is an explanatory diagram of a degassing operation. As illustrated in FIG. 9, when the degassing operation is started, the pressure adjustment mechanism 18 executes the depressurization operation. In other words, the space R₃ and the degassing path 75 are depressurized by the suction of air.

When the degassing path 75 is depressurized, the valve body 742 of the check valve 74 is separated from the valve seat 741 against the energization by the spring 743, and the degassing space Q and the degassing path 75 communicate with each other via the communication hole H_{B}. Therefore, the air in the degassing space Q is discharged to the outside of the apparatus via the degassing path 75. On the other hand, although the pressing portion 73 is deformed toward the side opposite to the movable film 71 by depressurization in the internal space, there is no influence on the pressure in the control chamber R_{C} (further, the movable film 71), and thus the opening/closing valve B[1] is maintained in a state of being closed.

In this embodiment, as illustrated in FIG. 5, the space R₃ has a wall 41a that faces the rear end surface 73c of the pressing portion 73, and a protrusion portion 41b that protrudes toward the pressing portion 73 is provided on the wall 41a. In this way, the protrusion portion 41b is provided on the wall 41a that faces the rear end surface 73c, and thus the contact area between the pressing portion 73 and the wall 41a is reduced. Therefore, it is possible to prevent the pressing portion 73 from sticking to the wall 41a due to dew condensation or the like. In addition, the protrusion portion 41b is provided on the wall 41a, and thus, when depressurizing the degassing path 75, it is possible to restrict the deformation of the pressing portion 73 to the side opposite to the movable film 71 and prevent damage caused by excessive deformation of the pressing portion 73. The protrusion portion 41b may be provided in a beam shape.

As described above, in the first embodiment, the pressure adjustment mechanism 18 is commonly used in the opening/closing of the opening/closing valve B[1] and the opening/closing of the check valve 74, and thus there is an advantage in that the configuration for controlling the opening/closing valve B[1] and the check valve 74 is simplified, compared to a configuration in which the opening/closing valve B[1] and the check valve 74 are controlled by each individual mechanism.

In addition, in the present embodiment, the pressing portion 73 for pressing the movable film 71 is provided, and the area of the front end surface 73b as the pressure receiving portion of the pressing portion 73 that presses the movable film 71 is smaller than the area of the rear end surface 73c that receives the supply pressure. Thus, it is possible to easily receive the supply pressure by the rear end surface 73c with a wide area, and reduce the reaction force from the movable film 71 by the front end surface 73b with a small area. Therefore, as the supply pressure, there is no need for high pressure. Further, the pressure of the pressure adjustment mechanism 18 that supplies the supply pressure required for opening the opening/closing valve B[1] has little influence on the change in the pressure of the ink in the space R₂, and thus it is possible to simplify the design of the pressure adjustment mechanism 18. Furthermore, the influence on the reaction force of the ink via the movable film 71 due to the pressure of the pressure adjustment mechanism 18 can be reduced, and thus it is possible to easily maintain the posture of the pressing portion 73. Therefore, it is possible to stably maintain the state where the opening/closing valve B[1] is opened.

Further, in the present embodiment, the pressure receiving plate 723 is provided on the movable film 71. Therefore, when the pressing portion 73 presses the movable film 71, it is possible to prevent deformation of the movable film 71 such as extension or tear of the movable film 71. In addition, the pressure receiving plate 723 is provided on the valve body 722 side, and thus it is possible to prevent the valve body 722 from being brought into direct contact with the movable film 71, thereby preventing deformation and breakage of the movable film 71 due to contact between the movable film 71 and the valve body 722.

In addition, in the present embodiment, the pressure receiving plate 723 has an area larger than the area of the front end surface 73b of the pressing portion 73, and thus, even in a case where the pressure receiving plate 723 and the front end surface 73b of the pressing portion 73 are misaligned, it is possible to reliably press the pressure receiving plate 723 by the front end surface 73b of the pressing portion 73.

Further, in the present embodiment, the thickness of the portion of the pressing portion 73 other than the front end, that is, the thickness of the portion of the pressing portion 73 other than the projection portion 73a having the front end surface 73b is thinner than the thickness of the portion at which the projection portion 73a is provided. Therefore, it is possible to easily deform the portion of the pressing portion 73 other than the front end, that is, the portion of the pressing portion 73 other than the projection portion 73a, and easily move the projection portion 73a having the front end surface 73b toward the movable film 71.

In addition, in the present embodiment, the wall 41a is provided on the side opposite to the movable film 71 with the pressing portion 73 interposed therebetween, and the protrusion portion 41b which protrudes and is brought into contact with the pressing portion 73 is provided on the wall 41a. Therefore, the protrusion portion 41b is provided on the wall 41a that faces the rear end surface 73c, and thus the contact area between the pressing portion 73 and the wall 41a is reduced. Therefore, it is possible to prevent the pressing portion 73 from sticking to the wall 41a due to dew condensation or the like. Further, the protrusion portion 41b is provided on the wall 41a, and thus, when depressurizing the degassing path 75, it is possible to restrict the deformation of the pressing portion 73 to the side opposite to the movable film 71 and prevent damage caused by excessive deformation of the pressing portion 73.

Further, the liquid ejecting unit 40 according to the present embodiment includes the valve mechanism unit 41 as the flow path structure, and the liquid ejecting portion 44 that changes the first pressure by ejecting the ink in the space R₂ as the storage chamber. Even though the ink in the space R₂ is consumed by ejection of the ink in the space R2 by the liquid ejecting portion 44, the movable film 71 operates based on the pressure in the space R₂, and thus it is possible to supply the ink from the space R₁ into the space R₂ by opening the opening/closing valve B[1]. Accordingly, it is possible to supply the ink to the liquid ejecting portion 44 with a constant pressure.

### Second Embodiment

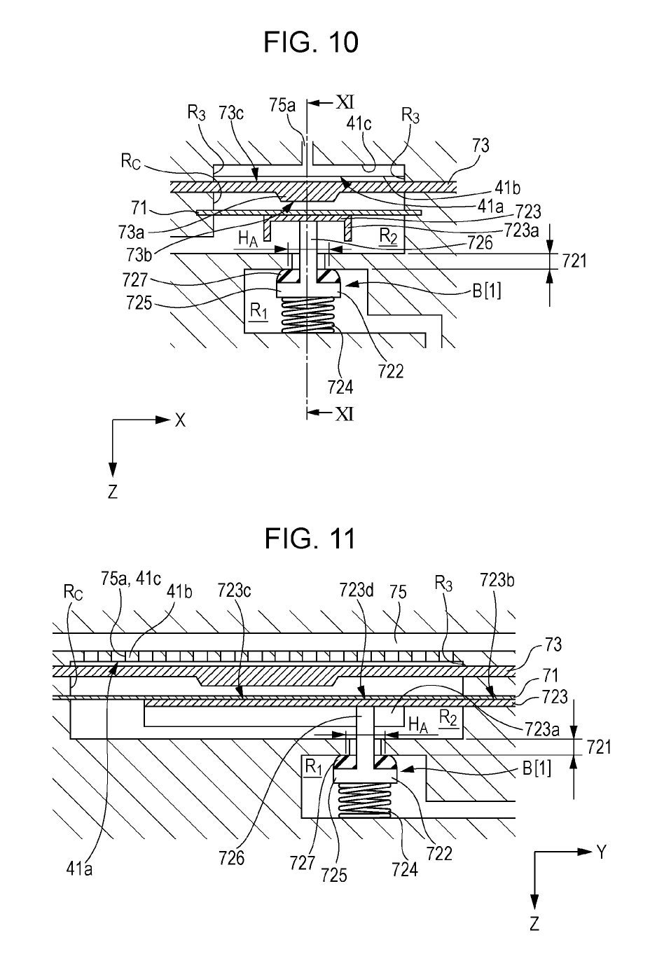

FIG. 10 is a sectional view of a main part of the valve mechanism unit according to a second embodiment of the invention. FIG. 11 is a sectional view taken along line XI-XI in FIG. 10. The members equivalent to those of the embodiment described above are denoted by the same reference numerals and the description thereof will not be repeated.

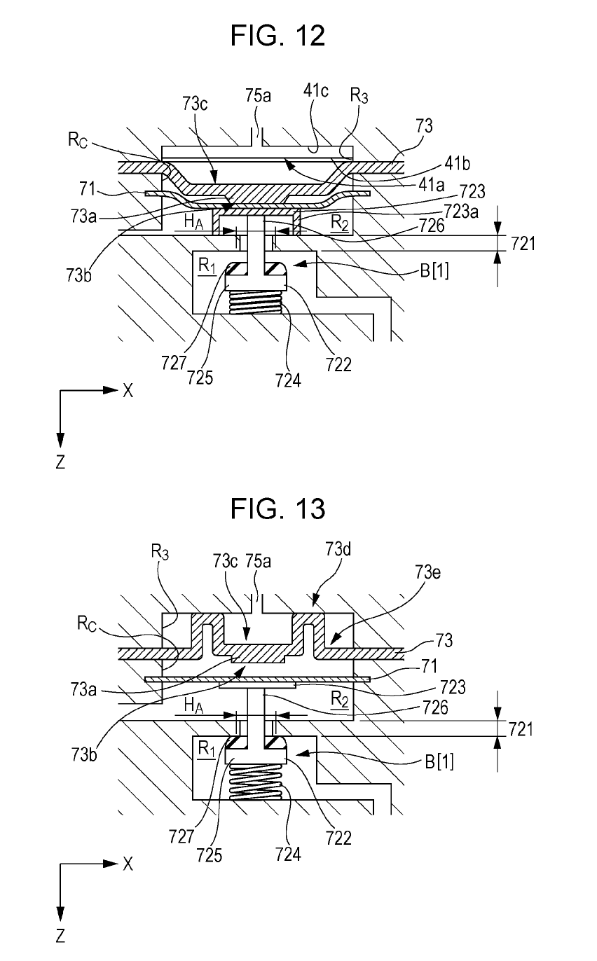

As illustrated in FIGS. 11 and 12, the pressure receiving plate 723 is provided on the surface of the movable film 71 that faces the valve seat 721. The pressure receiving plate 723 includes a return 723a away from the movable film 71. In the present embodiment, as illustrated in FIG. 10, the return 723a is provided by bending both ends of the pressure receiving plate 723 in the X-direction toward the Z-direction. The return 723a may be formed, for example, by molding without bending the pressure receiving plate 723. As illustrated in FIG. 11, the return may not be formed at the end portion of the pressure receiving plate 723 in the Y-direction. Of course, the return 723a may be provided at the end portion which is a free end of the pressure receiving plate 723 in the Y-direction.

In this way, the return 723a is provided on the pressure receiving plate 723, and thus the strength of the pressure receiving plate 723 can be increased. Therefore, when the pressure receiving plate 723 is pressed by the pressing portion 73 or the movable film 71, it is possible to prevent the pressure receiving plate 723 from being deformed. In addition, the direction of the return 723a of the pressure receiving plate 723 is a direction away from the movable film 71, and thus it is possible to prevent the movable film 71 from being damaged by the edge of the pressure receiving plate 723.

In the present embodiment, as illustrated in FIG. 12, the return 723a is provided in the space R₃, and when the movable film 71 is pressed by the pressing portion 73, the return 723a is brought into contact with the wall surface of the space R₃, that is, the valve seat 721. The height with which the return 723a is brought into contact with the wall surface of the space R₃ is set to the height in a state where the opening/closing valve B[1] is opened. In this way, the return 723a is brought into contact with the wall surface of the space R₃, and thus excessive deformation of the movable film 71 can be prevented, thereby preventing breakage of the movable film 71 and the pressing portion 73 due to excessive deformation.

In the present embodiment, the pressure receiving plate 723 is provided on the surface of the movable film 71 that faces the valve seat 721, but is not particularly limited thereto. The pressure receiving plate 723 may be provided on the surface of the movable film 71 that is opposite to the valve seat 721. In this case, the return 723a may be provided in a direction away from the movable film 71.

As illustrated in FIG. 11, the pressure receiving plate 723 includes a portion 723b whose one end portion is supported by the valve mechanism unit 41, a to-be-pressed portion 723c that is pressed by the pressing portion 73, and a contact portion 723d that is brought into contact with the valve body 722 between the portion 723b and the to-be-pressed portion 723c. That is, when viewed from the Z-direction in a plan view, the to-be-pressed portion 723c of the pressure receiving plate 723 that is pressed by the pressing portion 73 and the contact portion 723d that is brought into contact with the valve body 722 are not disposed at an overlapped position. In this way, the contact portion 723d of the pressure receiving plate 723 that is brought into contact with the valve body 722 is disposed between the portion 723b and the to-be-pressed portion 723c, and thus the movement amount of the valve body 722 is less than the press amount in which the movable film 71 is pressed by the pressing portion 73. Therefore, it is possible to improve the opening/closing accuracy of the valve body 722 by reducing variations in the position of the valve body 722. In other words, the movement amount of the contact portion 723d is less than the press amount in which the movable film 71 is pressed by the pressing portion 73, and thus, even though there are variations in the press amount in which the movable film 71 is pressed by the pressing portion 73, the influence on the contact portion 723d due to the variations in the press amount decreases. Accordingly, it is possible to improve the opening/closing accuracy of the valve body 722.

The pressing portion 73 similar to that of the first embodiment is provided between the control chamber R_{C} and the space R₃. The pressing portion 73 is configured with a plate-shaped member formed of an elastic material such as rubber, and the pressing portion 73 is provided so as to close the opening of the control chamber R_{C}. In the present embodiment, the pressing portion 73 is intended to elastically deform to the movable film 71 side in a convex shape when the degassing path 75 is pressurized by the pressurization operation of the pressure adjustment mechanism 18, and to have a plate shape when the pressurization operation is not performed.

The projection portion 73a that projects toward the movable film 71 is provided at the pressing portion 73, and the area of the front end surface 73b of the projection portion 73a is smaller than the area of the rear end surface 73c that receives the supply pressure. In the pressing portion 73, the thickness in the Z-direction of a portion other than the portion at which the projection portion 73a is provided is thinner than the thickness in the Z-direction of the portion at which the projection portion 73a is provided. That is, the projection portion 73a is formed by increasing the thickness of the plate-shaped member in the Z-direction. In this way, the thickness of the portion other than the portion at which the projection portion 73a is provided is thinner than that of the region at which the projection portion 73a is provided, and thus the portion other than the projection portion 73a in the pressing portion 73 can be easily deformed. In this regard, in a case where the thickness of the portion other than the projection portion 73a in the pressing portion 73 is the same as that of the projection portion 73a, the portion other than the projection portion 73a in the pressing portion 73 is unlikely to be deformed, and the portion at which the projection portion 73a is provided may be deformed. As a result, there is a concern that it is difficult to press the movable film 71 with high accuracy. In the present embodiment, the thickness of the portion other than the projection portion 73a is thinner than that of the projection portion 73a, and thus the portion other than the projection portion 73a can be easily deformed. In addition, the shape of the projection portion 73a can be stabilized, and thus it is possible to press the movable film 71 with high accuracy.

In a state where the pressurization operation is not performed by the pressure adjustment mechanism 18, the pressing portion 73 is disposed away from the movable film 71. In this way, the pressing portion 73 is disposed away from the movable film 71, and thus, when the pressing portion 73 is bent at an unexpected timing, it is possible to prevent the valve from opening. When the pressing portion 73 is brought into contact with the movable film 71, in a case where unexpected bending such as vibration or aging-deterioration of the pressing portion 73 occurs, there is a possibility that the valve body 722 is pressed and opened. Of course, the movable film 71 is pressed by the pressing portion 73, and thus it is possible to receive the pressure that the movable film 71 receives from the ink only by the front end surface 73b of the pressing portion 73. Thereby, it is possible to reduce a possibility that the pressing portion 73 is pressed by the pressure of the ink.

The wall 41a that faces the rear end surface 73c of the pressing portion 73 is provided in the control chamber R_{C}. The wall 41a includes a plurality of protrusion portions 41b that can be brought into contact with the pressing portion 73 and recess portions 41c that are provided between the plurality of protrusion portions 41b.

In the present embodiment, the protrusion portions 41b that extend in the X-direction and continuously project are disposed at intervals in the Y-direction.

An opening portion 75a that penetrates in the Z-direction and communicates with the degassing path 75 is provided to be opened to the bottom surface of each of the recess portions 41c provided between the plurality of protrusion portions 41b. That is, air from the pressure adjustment mechanism 18 is supplied from the recess portions 41c to the space R₃. In the present embodiment, the opening portion 75a that is opened to the degassing path 75 is formed at a portion of the bottom surfaces of the recess portions 41c, but is not particularly limited thereto. The opening portion 75a may be formed at all of the bottom surfaces of the recess portions 41c. In the present embodiment, although the degassing path 75 and the space R₃ communicate with each other in the Z-direction, the configuration is not particularly limited thereto. In the end portion of the recess portions 41c in the X-direction, the degassing path 75 and the space R₃ may communicate with each other in the X-direction or the Y-direction without communicating with each other in the Z-direction.

In this way, the plurality of protrusion portions 41b are provided on the wall 41a, and thus, when the degassing path 75 and the space R₃ are depressurized, the rear end surface 73c of the pressing portion 73 is brought into contact with the plurality of protrusion portions 41b. Therefore, it is possible to reduce the contact area between the rear end surface 73c of the pressing portion 73 and the wall 41a, and thus it is possible to prevent the pressing portion 73 from sticking to the wall 41a due to dew condensation or the like.

In addition, when the degassing path 75 and the space R₃ are depressurized, the rear end surface 73c of the pressing portion 73 is brought into contact with the plurality of protrusion portions 41b, and thus the deformation of the pressing portion 73 toward the side opposite to the movable film 71 is restricted. Therefore, excessive deformation of the pressing portion 73 can be prevented, and thus it is possible to prevent breakage of the pressing portion 73.

Further, in the present embodiment, the air of the pressure adjustment mechanism 18 is supplied from the plurality of recess portions 41c, and thus, even though one of the recess portions 41c is clogged, it is possible to operate the pressing portion 73. That is, in a case where only one recess portion 41c communicates with the degassing path 75, when the recess portion 41c is clogged, the pressing portion 73 cannot be operated. However, the plurality of recess portions 41c communicate with the degassing path 75, and thus, even though one recess portion 41c is clogged, it is possible to operate the pressing portion 73, thereby improving reliability.

As described above, in the present embodiment, the pressure receiving plate 723 is provided, and the return 723a is provided on the pressure receiving plate 723 away from the movable film 71. Therefore, the strength of the pressure receiving plate 723 can be increased, and thus, when the pressure receiving plate 723 is pressed by the pressing portion 73 and the movable film 71, it is possible to prevent deformation of the pressure receiving plate 723. In addition, the direction of the return 723a of the pressure receiving plate 723 is a direction away from the movable film 71, and thus, it is possible to prevent the movable film 71 from being scratched by the edge of the pressure receiving plate 723.

The return 723a is in the space R₂, and the movable film 71 is pressed by the pressing portion 73. Thus, the return 723a is brought into contact with the wall surface of the space R₂. As a result, excessive deformation of the movable film 71 can be prevented, thereby preventing breakage of the movable film 71 and the pressing portion 73 due to excessive deformation.

The pressure receiving plate 723 includes the portion 723b, the to-be-pressed portion 723c that is pressed by the pressing portion 73, and the contact portion 723d that is brought into contact with the valve body 722 between the portion 723b and the to-be-pressed portion 723c. As a result, variations in the contact portion 723d being in contact with the valve body 722 with respect to the variations in the to-be-pressed portion 723c can be reduced, and thus it is possible to improve accuracy in the position of the valve body 722, thereby improving the opening/closing accuracy of the valve body 722.

Further, in the present embodiment, the thickness of the portion of the pressing portion 73 other than the front end, that is, the thickness of the portion of the pressing portion 73 other than the projection portion 73a having the front end surface 73b is thinner than the thickness of the portion at which the projection portion 73a is provided. Therefore, it is possible to easily deform the portion of the pressing portion 73 other than the front end, that is, the portion of the pressing portion 73 other than the projection portion 73a, and easily move the projection portion 73a having the front end surface 73b toward the movable film 71.

Furthermore, the wall 41a is provided on the side opposite to the movable film 71 with the pressing portion 73 interposed therebetween, and the wall 41a includes the plurality of protrusion portions 41b that is brought into contact with the pressing portion 73 and the recess portions 41c provided between the plurality of protrusion portions 41b. In this way, the plurality of protrusion portions 41b are provided on the wall 41a, and thus, when the degassing path 75 and the space R₃ are depressurized, the rear end surface 73c of the pressing portion 73 is brought into contact with the plurality of protrusion portions 41b. Therefore, the contact area between the rear end surface 73c of the pressing portion 73 and the wall 41a can be reduced, and thus it is possible to prevent the pressing portion 73 from sticking to the wall 41a due to dew condensation or the like. Also, deformation of the pressing portion 73 toward the side opposite to the movable film 71 is restricted, and thus excessive deformation of the pressing portion 73 can be prevented, thereby preventing breakage of the pressing portion 73.

In addition, the plurality of recess portions 41c are provided, and air is supplied from each of the recess portions 41c. Thus, even though one recess portion 41c is clogged, it is possible to operate the pressing portion 73, thereby improving reliability.

### Third Embodiment

FIG. 13 is a sectional view of a main portion of the valve mechanism unit according to a third embodiment of the invention. The same members as those of the embodiments described above are denoted by the same reference numerals and the description thereof will not be repeated.

As shown in FIG. 13, the pressing portion 73 according to the present embodiment includes a projection portion 73a and first portions 73d and second portions 73e as bend portions.

The first portions 73d are provided so as to surround the periphery of the projection portion 73a provided at the center portion, and are bent so as to be folded back in the Z-direction. The first portions are deformed by a high supply pressure from the pressure adjustment mechanism 18. The deformation of the first portions 73d means that the bent portions are deformed so as to extend and the bend angles are changed.

The second portions 73e are provided so as to surround the first portions 73d at the outside of the first portions 73d, and are bent at approximately 90 degrees. The second portions 73e are deformed by a low supply pressure from the pressure adjustment mechanism 18. The deformation of the second portions 73e means that the bent portions are deformed so as to extend and the bend angles are changed.

In this way, the first portions 73d and the second portions 73e as bent portions are provided on the pressing portion 73, and thus it is possible to increase the area of the rear end surface 73c of the pressing portion 73 that receives the supply pressure from the pressure adjustment mechanism 18, thereby deforming the pressing portion 73 with a low supply pressure.

In addition, the first portions 73d and the second portions 73e as bent portions are provided on the pressing portion 73, and thus it is possible to increase the amount of displacement of the pressing portion 73, in particular, the amount of movement in the Z-direction of the portion in which the projection portion 73a is provided. That is, the pressing portion 73 is deformed so as to widen the bend angles of the first portions 73d and the second portions 73e as bent portions, and thus it is possible to greatly move the portion where the projection portion 73a that presses the movable film 71 is provided in the Z direction. The pressure required for deforming the pressing portion 73 so as to widen the bend angles of the first portions 73d and the second portions 73e as bent portions is smaller than the pressure required for deforming the flat plate-shaped pressing portion 73 according to the first and second embodiments. Therefore, the pressing portion 73 according to the present embodiment can increase the amount of deformation with a low supply pressure.

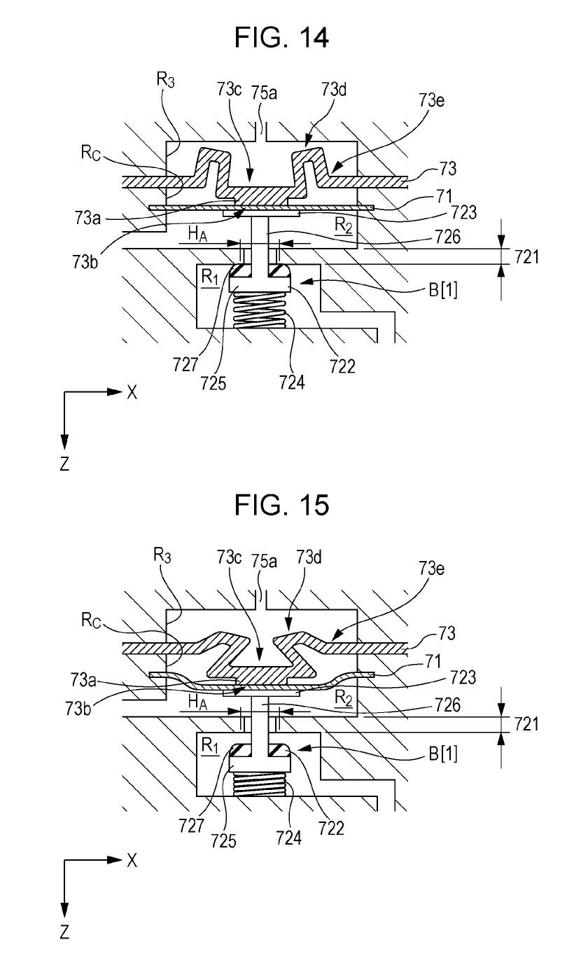

Further, in the present embodiment, the pressing portion 73 is provided with the first portions 73d that are deformed by a high supply pressure and the second portions 73e that are deformed by a low supply pressure, as bent portions. Therefore, it is possible to operate the valve mechanism unit, as illustrated in FIG. 14, as a second state where the second portions 73e are deformed with a low supply pressure and the movable film 71 is pressed to the extent that the opening/closing valve B[1] is not opened, and as illustrated in FIG. 15, as a first state where the first portions 73d the second portions 73e are deformed with a high supply pressure and the movable film 71 is pressed to the extent that the opening/closing valve B[1] is opened.

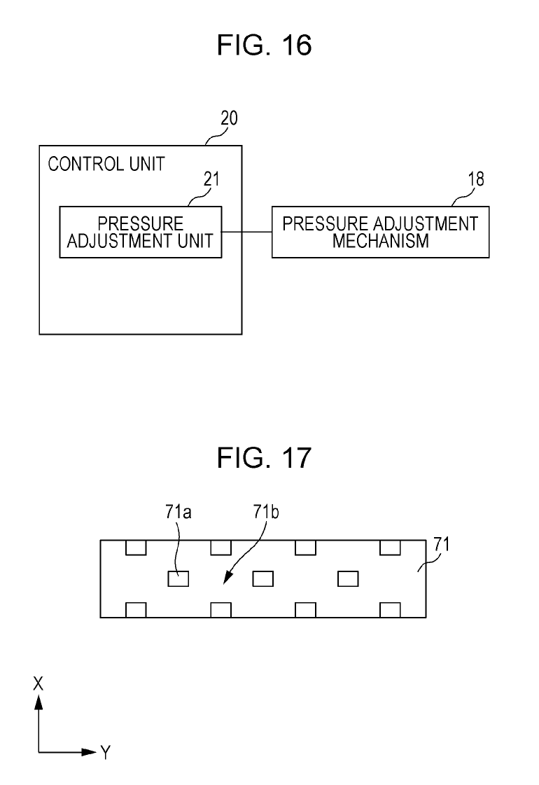

The first state and the second state can be switched by controlling the supply pressure of the pressure adjustment mechanism 18 by the control unit 20. Hereinafter, the control unit 20 will be described with reference to FIG. 16. FIG. 16 is a block diagram illustrating a function realization section of the control unit.

The control unit 20 has a function as a pressure adjustment unit 21 that controls the pressure adjustment mechanism 18. The pressure adjustment unit 21 causes the pressure adjustment mechanism 18 to perform the pressurization operation for supplying air to the flow path connected to the pressure adjustment mechanism 18, that is, the degassing path 75 or the like, and the depressurization operation for sucking air from the flow path, by controlling the pressure adjustment mechanism 18.

In this way, the pressure adjustment unit 21 repeatedly performs the pressurization operation for pressurizing the flow path connected to the pressure adjustment mechanism 18 to the extent to be in the second state illustrated in FIG. 14, and the depressurization operation for depressurizing the flow path, by controlling the pressure adjustment mechanism 18. Accordingly, fluctuation in the pressure in the ink in the space R₂ occurs, and it is possible to swing the meniscus of the ink in the nozzle N which communicates with the space R₂. The meniscus of the ink in the nozzle N is swung by the pressure adjustment mechanism 18, and thus it is possible to prevent the ink from drying. In addition, the meniscus of the ink in the nozzle N can be greatly swung by using the pressure adjustment mechanism 18, compared to the case of using the piezoelectric element 484. The ink may be ejected from the nozzle N by swing. In this way, the meniscus of the ink in the nozzle N is swung by using the pressure adjustment mechanism 18, and thus there is no need to use the piezoelectric element 484, thereby preventing the lifetime of the piezoelectric element 484 from shortening. Of course, the swing of the meniscus of the ink in the nozzle N by using the pressure adjustment mechanism 18 and the swing of the meniscus of the ink in the nozzle N by driving the piezoelectric element 484 may be used together. Even in this case, the meniscus of the ink in the nozzle N can be greatly swung.

Further, the pressure adjustment unit 21 controls the pressure adjustment mechanism 18 to perform initial filling and the like by pressurizing the flow path connected to the pressure adjustment mechanism 18 to be in the first state as illustrated in FIG. 15 and opening the opening/closing valve B[1].

As described above, in the present embodiment, the pressing portion 73 includes the first portions 73d and the second portions 73e as bent portions. Therefore, it is possible to increase the area of the rear end surface 73c that receives the supply pressure. Further, the pressing portion 73 is deformed by widening the first portions 73d and the second portions 73e as bent portions, and thus it is possible to greatly deform the pressing portion 73 with a low supply pressure.

In addition, the pressing portion 73 presses the movable film 71 to be in the first state where the movable film 71 is pressed to the extent that the opening/closing valve B[1] is opened and the second state where the movable film 71 is pressed to the extent that the opening/closing valve B[1] is not opened. Therefore, it is possible to operate the pressing portion 73 in multiple stages, and the movable film 71 can be easily pressed in multiple stages.

In the present embodiment, the control unit 20 as a control portion that controls so as to swing the meniscus of the ink in the nozzle N of the liquid ejecting portion 44 by pressing the movable film 71 in the second state, is provided. In this way, the meniscus of the ink in the nozzle N is swung in the second state, and thus it is possible to prevent the ink from drying. In addition, the meniscus of the ink in the nozzle N can be greatly swung by using the valve mechanism unit 41, compared to the case of using the piezoelectric element 484. The ink may be ejected from the nozzle N by swing. Further, the meniscus of the ink in the nozzle N is swung by using the valve mechanism unit 41, and thus there is no need to use the piezoelectric element 484, thereby preventing the lifetime of the piezoelectric element 484 from shortening.

Furthermore, in the present embodiment, the pressing portion 73 includes the first portions 73d that are deformed with a high supply pressure and the second portions 73e that are deformed with a low supply pressure. Thus, it is possible to easily realize the first state where the opening/closing valve B[1] is opened by the deformation of the first portions 73d and the second state where the opening/closing valve B[1] is not opened by the deformation of the second portions 73e.

### Fourth Embodiment

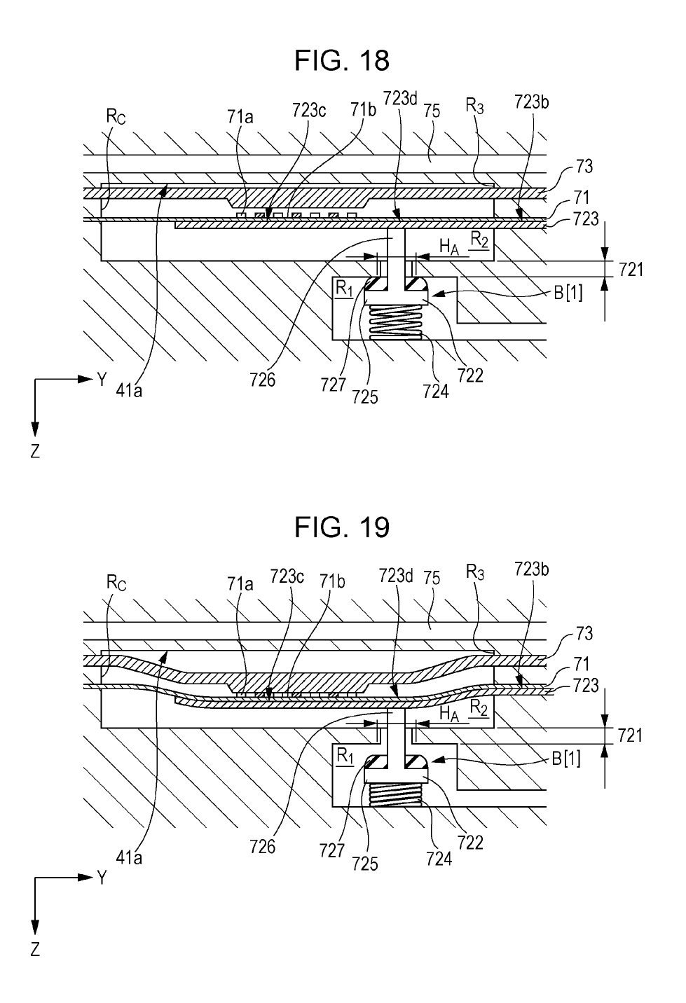

FIG. 17 is a plan view of the movable film according to a fourth embodiment of the invention, and FIG. 18 is a sectional view of a main part of the pressure adjustment mechanism. The same members as those of the embodiments described above are denoted by the same reference numerals and the description thereof will not be repeated.

As illustrated in FIGS. 17 and 18, a plurality of protrusion portions 71a that are independently provided in the form of islands, and recess portions 71b that are provided between the plurality of protrusion portions 71a are included in the portion of the movable film 71 that is pressed by the pressing portion 73. In the present embodiment, the plurality of protrusion portions 71a and recess portions 71b provided between the plurality of protrusion portions 71a are formed by bonding the plurality of island-shaped protrusion portions 71a to the surface of the movable film 71 that is opposite to the pressing portion 73. In the present embodiment, the plurality of protrusion portions 71a are disposed such that three rows of protrusion portions 71a provided in parallel in the Y-direction are provided in the X direction and the rows of protrusion portions 71a adjacent to each other in the X-direction are provided so as to be shifted by a half pitch of the pitch between the protrusion portions 71a constituting each row.

In this way, the plurality of protrusion portions 71a and the recess portions 71b are provided in the portion of the movable film 71 that is pressed by the pressing portion 73, and thus, as illustrated in FIG. 19, when the pressure adjustment mechanism 18 performs the pressurization operation, the front end surface 73b of the pressing portion 73 is brought into contact with only the front end surfaces of the plurality of protrusion portions 71a. Therefore, the contact area between the pressing portion 73 and the movable film 71 can be reduced, and thus it is possible to prevent the pressing portion 73 from sticking to the movable film 71 due to dew condensation or the like.

In the present embodiment, although the plurality of protrusion portions 71a are bonded to the movable film 71, the configuration is not particularly limited thereto. For example, irregular shapes may be formed on the surface of the plate-shaped member, and the plate-shaped member may be bonded to the movable film 71. In addition, irregular shapes may be provided by roughening the surface of the movable film 71. The roughening of the surface of the movable film 71 means processing of making the surface of the movable film 71 rough, for example, by dry etching, blasting processing, or wet etching, or forming a film having a rough surface. In this way, the surface of the portion where the pressing portion 73 is brought into contact with the movable film 71 is roughened, and thus it is possible to prevent the pressing portion 73 from sticking to the movable film 71 due to dew condensation or the like.

In the present embodiment, although the pressure receiving plate 723 is provided on the movable film 71 at the valve body 722 side, the configuration is not particularly limited thereto, and the pressure receiving plate 723 may be provided on the movable film 71 at the pressing portion 73 side. In this case, a plurality of protrusion portions and recess portions may be provided in the portion of the pressure receiving plate 723 that is pressed by the pressing portion 73.

In the present embodiment, although the plurality of protrusion portions 71a and the recess portions 71b are provided in the portion of the movable film 71 that is pressed by the pressing portion 73, the configuration is not limited thereto, and for example, the plurality of protrusion portions and the recess portions may be provided at the front end surface 73b of the pressing portion 73. Of course, the plurality of protrusion portions and the recess portions may be provided in both the movable film 71 and the pressing portion 73.

In the present embodiment, although the plurality of independent protrusion portions 71a are provided in the form of islands, the configuration is not limited thereto. For example, the configuration is not limited to the plurality of protrusion portions 71a, and one protrusion portion 71a may be provided. In a case where only one protrusion portion 71a is provided, the protrusion portion 71a may be provided at the central portion in the X-direction and the Y-direction. In addition, a continuous bar-shaped protrusion portion that extends in the Y-direction may be provided at the center of the movable film 71 in the X-direction. Of course, two or more of the island-shaped or bar-shaped protrusion portions may be provided.

### OTHER EMBODIMENTS

Although the embodiments according to the invention are described above, the basic configuration of the invention is not limited thereto.

For example, although the opening/closing valve B[1] according to each of the above-described embodiments is configured to be closed by energizing the valve body 722 by the energization of the spring 724, the configuration is not limited thereto, and the opening/closing valve B[1] may be configured to be closed by the weight of the valve body 722.

In each of the above-described embodiments, although the configuration in which the flow path provided with the opening/closing valve B[1] communicates with the space R₂ as the storage chamber is exemplified, the configuration is not limited thereto. For example, a configuration in which, the flow path provided with the opening/closing valve B[1] communicates with the power source for pressure-feeding the liquid to the storage chamber, that is, the liquid pressure feed mechanism 16 without communicating with the space R₂ as the storage chamber, in which the liquid pressure feed mechanism 16 operates to pressure-feed the ink to the space R₂ as the storage chamber by opening the opening/closing valve B[1], and as a result, in which the first pressure on one side of the movable film 71 is increased may be used. In other words, the flow path that is opened and closed by the opening/closing valve B[1] may be a flow path for fluids other than ink, and the ink may flow by opening and closing of the opening/closing valve B[1].

The movable film 71 as the pressure receiving portion may be any movable element as long as the movable film 71 can move according to the balance between the first pressure and the second pressure, and the material of the movable film 71 may be, for example, a membrane, a film, a metal, or the like. The shape of the movable film 71 may be a flat shape, may be a so-called bellows shape in which bending is repeated, or may be a bag-shaped body.

In each of the above-described embodiments, although the movable film 71 as the pressure receiving portion partitions the space R₂ as the storage chamber and the control chamber R_{C}, the configuration is not limited thereto, and the movable film 71 may be provided as a bag-shaped body in the inside of the storage chamber.

Although the pressing portion 73 is made of an elastic member such as rubber, the configuration is not limited thereto, and the pressing portion 73 may be made of a flexible resin or the like.

A plurality of front ends that press the movable film 71 may be provided in the pressing portion 73. In a case where the plurality of front ends are provided in the pressing portion 73, for example, similarly to the above-described third embodiment, the first state where the movable film 71 is pressed by all of the front ends with a high supply pressure to the extent that the valve is opened, and the second state where the movable film 71 is pressed by only a part of the front ends with a low supply pressure to the extent that the valve is not opened, may be switched. That is, in a case where the plurality of front ends are provided in the pressing portion 73, a part of the front ends may be set as the second portions for the second state, and all of the front ends may be set as the first portions for the first state.

In each of the above-described embodiments, although the bubbles in the degassing space Q are removed by depressurizing the degassing space Q, the purpose for depressurizing is not particularly limited thereto. For example, the depressurized space may be used to collect the ink in the flow path together with the air bubble, by communicating with the flow path through which the ink passes via a one-way valve and opening the one-way valve at the time of depressurizing the space. In other words, the depressurized space may be used for the purpose of collecting the air bubble included in the ink. Of course, the depressurized space may also be used for another use other than the purpose of collecting the air bubble included in the ink. As another use, for example, by changing the volume of the damper chamber for absorbing the pressure variation in the flow path due to the pressurization of the space, the characteristics of the damper chamber may be changed. Furthermore, the space may be used to remove the dust attached to the vicinity of the nozzles N by suction, by opening the space so as to face the nozzles N and depressurizing the space.

In a case where depressurization is used in order to remove the air bubble in the degassing space Q, at least a portion of the depressurized space is preferably formed by a sheet-shaped gas-permeable member (for example, a thin film of polyacetal, polypropylene, polyphenylene ether, or the like), or a rigid wall having a thickness enough to exhibit gas permeability (for example, a rigid wall obtained by forming the flow path unit 42 including gas-permeable partitions with a plastic material such as POM (polyacetal), m-PPE (modified polyphenylene ether), PP (polypropylene), or the like, or alloys of these materials, and typically making the thickness of the rigid wall to approximately 0.5 mm). Alternatively, in a case where the room that communicates with the room formed by the sheet-shaped member or the rigid wall via a valve corresponds to the depressurization space, the depressurization space may be formed by a thermosetting resin, metal, or the like. In a case where the space is used in order to remove the dust attached to the vicinity of the nozzles N by suction using the depressurization to the space, the space is preferably formed by a thermosetting resin, metal, or the like.

In each of the above-described embodiments, although air as the fluid from the pressure adjustment mechanism 18 as the fluid supply source is illustrated, the fluid is not particularly limited thereto. As the fluid, inert gas, liquid used for ink, liquid other than ink, or the like may be used.

In each of the above-described embodiments, although the piezoelectric element 484 is used as a pressure generating unit that causes a pressure change in the pressure chamber S_{C}, as the piezoelectric element 484, for example, a thin film type piezoelectric element in which electrodes and a piezoelectric material are stacked and formed by film formation and lithography, a thick film type piezoelectric element formed by a method such as attaching of a green sheet, or a longitudinal vibration type piezoelectric element in which a piezoelectric material and an electrode forming material are alternately laminated and the laminated layers are extended in the axial direction may be used. As a pressure generating unit, an element in which a heating element is disposed in the pressure chamber S_{C} and a droplet is discharged from the nozzle by bubbles generated by heat generation of the heating element, or an element in which static electricity is generated between the vibration plate and the electrode and a droplet is discharged from the nozzle by deforming the vibration plate by the electrostatic force may be used.

In the above-described embodiments, although the configuration in which the liquid ejecting unit 40 includes the valve mechanism unit 41 as the flow path structure is illustrated, the configuration is not limited thereto, and the liquid ejecting unit 40 may be provided with the valve mechanism unit 41 as the flow path structure. That is, the valve mechanism unit 41 and the place where the liquid ejecting portion 44 may be provided at different places from each other.

The invention can be broadly applied to a liquid ejecting apparatus in general, and for example, be applied to a recording head such as various ink jet recording heads used in an image recording apparatus such as a printer, a color material ejecting head used for manufacturing a color filter such as a liquid crystal display, an organic EL display, an electrode material ejecting head used for forming an electrode such as an FED (field emission display), and a liquid ejecting apparatus using a bioorganic material ejecting head used for manufacturing a biochip.

The invention can be broadly applied to a flow path structure in general, and can be used for devices other than a liquid ejecting apparatus and a liquid ejecting unit.

The invention may be realized by combining two or more arbitrarily selected embodiments in the above-described embodiments 1 to 4 and other embodiments, or may be realized by combining arbitrary configurations of these embodiments.

What is claimed is:

1. A flow path structure, comprising:
a storage chamber for storing a liquid;
a pressure receiver configured to receive a first pressure inside the storage chamber and a second pressure outside the storage chamber;
a valve configured to change the first pressure according to a movement of the pressure receiver; and
a pressing portion configured to press the pressure receiver according to a supply pressure of fluid from a fluid supply source,
wherein an area of the front end of the pressing portion for pressing the pressure receiver is smaller than an area of a rear end for receiving the supply pressure.

2. The flow path structure according to claim 1, further comprising:
a pressure receiving plate provided on the pressure receiver.

3. The flow path structure according to claim 2,
wherein the pressure receiving plate is larger than the front end.

4. The flow path structure according to claim 2,
wherein the pressure receiving plate includes a return that is separated from the pressure receiver.

5. The flow path structure according to claim 4,
wherein the return is in the storage chamber and brought into contact with the storage chamber when the pressure receiver is pressed by the pressing portion.

6. The flow path structure according to claim 2,
wherein the pressure receiver includes a portion whose one end portion is supported by the flow path structure, a to-be-pressed portion to be pressed by the pressing portion, and a contact portion which is brought into contact with the valve between the portion and the to-be-pressed portion.

7. The flow path structure according to claim 1,
wherein, in the pressing portion, the thickness of the portion other than the front end is thinner than the thickness of the front end.

8. The flow path structure according to claim 1,
wherein the pressing portion includes bent portions.

9. The flow path structure according to claim 1,
wherein a wall is provided on a side opposite to the pressure receiver with the pressing portion interposed therebetween,
wherein the wall has a plurality of protrusion portions that are brought into contact with the pressing portion and recess portions provided between the plurality of protrusion portions.

10. The flow path structure according to claim 9,
wherein a plurality of recess portions are provided, and
wherein the fluid is supplied from each of the recess portions.

11. The flow path structure according to claim 1,
wherein the pressure receiver includes a plurality of protrusion portions and recess portions provided between the plurality of protrusion portions at a position to be pressed by the pressing portion.

12. The flow path structure according to claim 1,
wherein the pressing portion presses the pressure receiver to be in a first state where the pressure receiver is pressed to the extent that the valve is opened, and a second state where the pressure receiver is pressed to the extent that the valve is not opened.

13. The flow path structure according to claim 12,
wherein the pressing portion includes first portions to be deformed with a high supply pressure and second portions to be deformed with a low supply pressure, and
wherein the first state is made by the deformation of the first portions, and the second state is made by the deformation of the second portions.

14. A liquid ejecting unit, comprising:
a flow path structure according to claim 1; and
a liquid ejecting portion that changes the first pressure by ejecting the liquid in the storage chamber.

15. A liquid ejecting unit, comprising:
a flow path structure according to claim 2; and
a liquid ejecting portion that changes the first pressure by ejecting the liquid in the storage chamber.

16. A liquid ejecting unit, comprising:
a flow path structure according to claim 3; and
a liquid ejecting portion that changes the first pressure by ejecting the liquid in the storage chamber.

17. A liquid ejecting unit, comprising:
a flow path structure according to claim 4; and
a liquid ejecting portion that changes the first pressure by ejecting the liquid in the storage chamber.

18. A liquid ejecting unit, comprising:
a flow path structure according to claim 5; and
a liquid ejecting portion that changes the first pressure by ejecting the liquid in the storage chamber.

19. A liquid ejecting unit, comprising:
a flow path structure according to claim 6; and
a liquid ejecting portion that changes the first pressure by ejecting the liquid in the storage chamber.

20. A liquid ejecting apparatus, comprising:
a flow path structure according to claim 1;
a liquid ejecting portion that changes the first pressure by ejecting the liquid in the storage chamber from nozzles; and
a control unit that controls the flow path structure so as to swing the meniscus of the liquid in the nozzles of the liquid ejecting portion by pressing the pressure receiving portion in the second state.
